(19) United States
(12) Patent Application Publication
(10) Pub. No.: US 2017/0235849 A1
(43) Pub. Date: Aug. 17, 2017

(54) MATCHING SYSTEM AND METHOD PSYCHOMETRIC INSTRUMENT SYSTEM AND METHOD AND SYSTEM AND METHOD USING SAME

(71) Applicant: Jacob Research Institute, LLC, Riverside, CA (US)

(72) Inventor: Keith John Jacob, Moreno Valley, CA (US)

(21) Appl. No.: 15/377,823

(22) Filed: Dec. 13, 2016

Related U.S. Application Data
(63) Continuation of application No. 14/996,883, filed on Jan. 15, 2016, now abandoned.

(51) Int. Cl. G06F 17/30; G06Q 30/02; G06Q 50/00

(52) U.S. Cl. CPC G06F 17/30979; G06Q 50/01; G06Q 30/0203

(57) ABSTRACT

Embodiments provide systems and methods including a psychometric instrument, systems and methods for matching individuals in personal relationships, systems and methods for analyzing and predicting compatibility between individuals in relationships, systems and methods for advising individuals in relation to personal relationships, systems and methods for matching individuals with jobs, and, systems and methods for management of individuals to perform work in organizations.

### CROSS-REFERENCE TO RELATED APPLICATION

This application is related to U.S. Utility patent application Ser. No. 14/996,883 filed Jan. 15, 2016. This Application expressly incorporates by reference to the full extent as though appearing herein U.S. Utility patent application Ser. No. 14/996,883 filed Jan. 15, 2016.

### FIELD OF THE INVENTION

The present disclosure relates to psychometric instruments for individual assessment and modeling. The disclosure further relates to systems, apparatuses and methods using psychometric instruments. The disclosure also relates to systems and methods for matching individuals considering personal relationships. The disclosure also relates to systems and methods for predicting compatibility and incompatibility between individuals in personal relationships. The disclosure also relates to systems and methods for analyzing relationship issues between individuals in personal relationships. The disclosure also relates to systems and methods for advising individuals in personal relationships. The disclosure also relates to systems and methods for matching individuals with job opportunities. The disclosure also relates to systems and methods for management of individuals to perform work in organizations.

### BACKGROUND OF THE INVENTION

Approximately 85% of couples are in a mismatched relationship. Of those relationships, 50% of them end up in divorce. People date and often marry based on their social personality.

A number of psychometric instruments may be utilized for testing and assessment of individual personality. One, for example, is the Minnesota Multiphasic Personality Inventory (MMPI). Another, for example, is the 16 Personality Factor Questionnaire (acronym: 16PF) developed by Raymond Cattell. Another is the Myers-Briggs Type Indicator Instrument® (MBTI).

There are a number of matching services in both the personal and public arenas. Some of these services seek to match individuals romantically, while other services match prospective employees to employers.

### BRIEF SUMMARY OF THE INVENTION

This summary presents integral concepts in a simplified form as a prelude to the more detailed disclosure that is presented herein. Unless otherwise defined, all terms (including technical and scientific terms) used herein have the same meaning as commonly understood by one of ordinary skill in the art to which this disclosure belongs. It may be further understood that terms, such as those defined in commonly used dictionaries, should be interpreted as having a meaning that is consistent with their meaning in the context of the relevant art and the present disclosure, and may not be interpreted in an idealized or overly formal sense unless expressly so defined herein.

The techniques utilized by dating and matchmaking services typically focus on superficial lifestyle variables, such as a person's preferences, like going to the beach or the movies, or their appearance or height. Such variables are referenced herein as social personality variables or superficial variables. In accordance with disclosed subject matter, superficial variables are not reliable to determine relational compatibility between two individuals. In whether two individuals are compatible enough, for example, to sustain a long-term healthy relationship. In accordance with disclosed subject matter, superficial variables may be of limited value for addressing or predicting aspects of social compatibility or superficial compatibility between two individuals. According to disclosed subject matter, a system may include primary variables which are not superficial variables. It will be understood that, as used herein, “primary variable” means primary relationship personality variables. According to disclosed subject matter, primary relationship personality variables may include the following: (a) need for communication, (b) need for intimacy, (c) interactivity (e.g., need for conflict resolution), and (d) adaptability (e.g., tolerance of differences). In an embodiment, primary relationship personality variables may be limited to the group of variables consisting of: (a) need for communication, (b) need for intimacy, (c) interactivity (e.g., need for conflict resolution), and (d) adaptability (e.g., tolerance of differences).

According to disclosed subject matter, a system may include primary relationship personality variables that are sufficient for addressing complexity of variables that may be considered to determine compatibility between two individuals. According to disclosed subject matter, a system may include primary relationship personality variables that are sufficient for determining or predicting whether two individuals are sufficiently compatible for a healthy long-term relationship to be sustained between them. In some embodiments of disclosed subject matter, it may be considered that “compatibility” between individuals is sufficient where a personal relationship that may be characterized as healthy or normal exists for a long-term period. It will be understood that in some embodiments, for example, a long-term period may be a period of at least 8 years. In some embodiments, a system may include both primary relationship personality variables that are sufficient for addressing complexity in determining compatibility between two individuals, and also may include superficial variables that address less complex, limited aspects of compatibility between two individuals. According to disclosed subject matter, a method includes considering primary relationship personality variables which are not superficial variables. According to disclosed subject matter, a method may include considering primary relationship personality variables that are sufficient for addressing complexity that may be considered to determine compatibility between two individuals. According to disclosed subject matter, a method may include both considering primary relationship personality variables that are sufficient for addressing the complexity of variables that may be considered to determine compatibility between two individuals, and considering superficial variables that do not address complexity and thus may be considered to determine only limited aspects of compatibility between two individuals.

Businesses may utilize older tests, such as the Four Temperaments Test (O4TS), which focus on identifying psychological disorders or temperaments, for addressing or predicting compatibility between individuals in a prospective work relationship in a business or other organization.

Other tests may be personalized to suit individual needs of a user. Such tests may focus on productivity. According to disclosed subject matter, a system may include disproportionate consideration or emphasis on variables or elements, such as personality, for example, that have disproportionate impact for determining productivity. According to disclosed subject matter, a system for matching individuals for positions to perform work in organizations may include primary variables. Disclosed subject matter recognizes and satisfies need for improved systems that match individuals in a scientifically accurate way. Disclosed subject matter provides a social network having a system for matching individuals in a scientifically accurate way. Embodiments may use a neuro-social network to meet the matching needs of both individuals and businesses. The present disclosed subject matter theorizes that relationships are at the center of a compatible fit whether in a business, family or marriage. These relationships are based on the effect of an individual's neural network and neurohormones, which regulate how individuals interact with and relate to each other, primarily what we refer to as “relationship personality”. Disclosed subject matter provides a system for predicting compatibility between individuals considering prospective personal relationships, wherein the system considers relationship personality variables for each individual. Disclosed subject matter also provides a system for predicting compatibility between individuals considering a prospective business or employment relationship, wherein the system considers relationship personality variables for individuals in the prospective business or employment relationships.

In embodiments, a series of tests may measure relationship personality variables of an individual and may enable the satisfaction that individuals are likely to experience years into the relationship to be identified. The present disclosed subject matter uses a “needs based” model of high and low needs. The tests can identify needs by a user's personality levels for a variety of relational variables that are important to a relationship, such as communication, intimacy, adaptability, and interactivity. Additionally, the tests also use social variables to identify compatibility between two individuals that also help to strengthen the relationship. These two sets of variables complement each other and reinforce the algorithm's results.

The disclosure may relate to the operation of a matching service for individuals based primarily on their relational and neuro-social personality. Specifically, the disclosure may use a number of matching intelligence and personality tests to determine if two individuals are compatible and what differences they may have that may affect long-term happiness and stability in the relationship. The disclosure may match individuals professionally, personally and relationally; these matches include, but are not limited to: matching singles with other singles, analyzing couples' compatibilities and differences as well as unspoken needs; matching individuals with a study buddy or helping businesses who wish to improve hiring processes, sales, and productivity.

The system may comprise a communications network configured to enable the transfer of information between one or more constituent elements of the system. The network may be wired or wireless. Suitable networks include, but are not limited to LAN, WLAN, WiFi, Ethernet, 3G, 4G, etc.

Descriptions of certain illustrative aspects are described herein in connection with the annexed Figures. These aspects are indicative of various non-limiting ways in which the disclosed subject matter may be utilized, all of which are intended to be within the scope of the disclosed subject matter. Other advantages, emerging properties, and features may become apparent from the following detailed disclosure when considered in conjunction with the associated Figures that are also within the scope of the disclosure.

### BRIEF DESCRIPTION OF THE DRAWINGS

The novel features believed characteristic of the disclosed subject matter may be set forth in any claims that are filed later. The disclosed subject matter itself, however, as well as a preferred mode of use, further objectives, and advantages thereof, may best be understood by reference to the following detailed description of an illustrative embodiment when read in conjunction with the accompanying drawings, wherein:

FIG. 1 is a schematic view of an illustrative embodiment of a matching system in accordance with the present disclosure.

FIG. 2 displays an alternative computing system and related peripherals that may operate with the psychometric instrument system, apparatuses and method, and system, apparatuses, and method using the same in accordance with embodiments.

FIG. 3 is a flow diagram illustrating an exemplary method for optimal matching of individuals seeking to establish relationships.

FIG. 4A is a tabular illustration showing structure and contents of an empirical database generated from selected answers to exemplary questions in an embodiment.

FIG. 4B is a tabular illustration showing structure and contents of an empirical database generated from selected answers to exemplary questions in an embodiment.

FIG. 5 is a representative listing of social compatibility categories assessed, and individual preferences in the same, that may be used in an embodiment.

FIG. 6 is a representative listing of dichotomous personality traits that may be identified and used in an embodiment.

FIG. 7 is an illustrative description of four binary personality types generated from selected answers to exemplary questions in an embodiment.

FIG. 8 is an exemplary listing of binary matching tests that may be selectable by individuals and used in an embodiment.

FIG. 9 is an exemplary listing of disciplines that may be used in an embodiment.

FIG. 10 is an exemplary listing of platform applications that may provide offerings of products, services or both, in an embodiment.

FIG. 11 is a view of a displayed registration page in an embodiment.

FIG. 12 is a view of an exemplary displayed listing of binary matching tests that may be selected and used in an embodiment.

FIG. 13 is a view of an exemplary displayed start page in an embodiment.

FIG. 14 is an exemplary listing of questions in an embodiment.

FIG. 15 is an exemplary listing of questions in an embodiment that may be utilized, for example, to inform professional decisions relating to individuals.

FIG. 16 is an exemplary listing of questions in an embodiment that may be utilized, for example, to inform educational decisions relating to individuals.

FIG. 17 is an exemplary listing of questions in an embodiment that may be utilized, for example, to inform career decisions relating to individuals such as students.

FIG. 18 is a composite image including a photographic depiction of an individual and a representation of a binary personality model assigned in an exemplary embodiment.

FIG. 19 is a flow diagram illustrating an exemplary method for optimal matching of individuals seeking to establish relationships in accordance with embodiments.

### DETAILED DESCRIPTION OF ILLUSTRATIVE EMBODIMENTS

Reference now should be made to the drawings, in which the same reference numbers are used throughout the different figures to designate the same components.

The terminology used herein is for the purpose of describing particular embodiments only and is not intended to be limiting. As used herein, the singular forms “a”, “an”, and “the” are intended to include the plural forms as well, unless the context clearly indicates otherwise. It may be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although described with reference to personal computers and the Internet, one skilled in the art could apply the principles discussed herein to any computing or mobile computing environment. Further, one skilled in the art could apply the principles discussed herein to communication mediums beyond the Internet.

It will be appreciated that for simplicity and clarity of illustration, where considered appropriate, reference numerals may be repeated among the figures to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

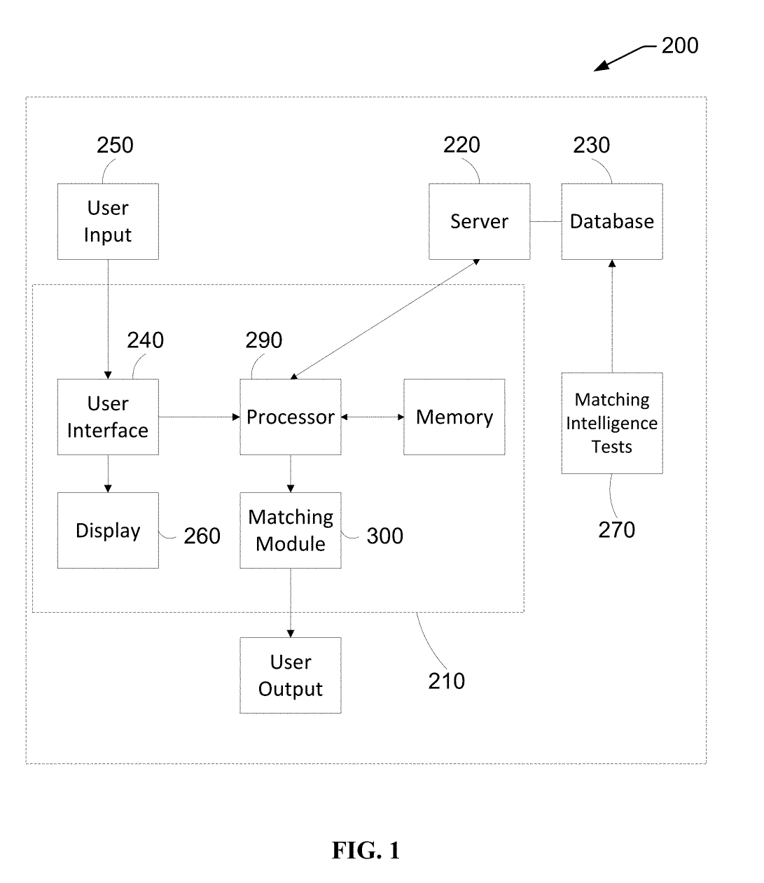

FIG. 1 is a schematic view of an illustrative embodiment of a matching system 200 in accordance with the present disclosure. A user, such as, but not limited to a single user, a married user, a business user, and an education user may utilize the internet with a computing system 210, such as for example, computing system 1, in conjunction with a web server 220 a database 230 in order to perform one or more high/low matching intelligence tests. The web server 220 may provide to computing system 210, the one or more high/low matching intelligence tests accessible by the user via a user interface 240. The user interface may further accept user input 250 via an individual. The user input 250 may be input into the computing system 210 in response to the one or more high/low matching intelligence tests. In embodiments, a display 260 may be linked to the user interface 240. The web server 220 may retrieve matching intelligence tests 270 and any information concerning the matching intelligence tests 270 via database 230. Database 230 may house various criteria concerning specific tests and questions to be given to computing system 210.

In response to input 250 by the user in relation to the tests, an algorithm embodied within the matching module 280, in conjunction with a processor 300, may analyze the responses (input 250) to the questions given to the user in order to group the user into one of a set of four identified personality categories or any combination thereof. In embodiments, computing system 210 may be directly linked to database 230. The database may additionally house one or more applications and/or website links that may be deployable on computing system 210 or on another user electronic device. The applications and/or website links may be assigned and presented to the user based on the personality category assigned to the user by the algorithm found on the matching module. A memory 310 may be utilized to store, on the computing system 210, any relevant information concerning the matching intelligence tests 270. In embodiments, the applications and/or website links may be related to subjects such as, but are not limited to a dating website, dating, match-making portal, chat room, coaching, counseling, therapy, education, training, consulting, workshops, and seminars.

In embodiments, the set of four identified personality categories may comprise a communication dimension, an intimacy dimension, an interactive dimension, and an adaptability dimension. Each of the set of four identified personality categories may comprise a high dimension and a low dimension. The personality categories and a high/low dimension may be assigned to an individual utilizing the system for analyzing current and/or future relationships. This means that there may be fourteen personality codes on a scale of the system that may be assigned to an individual: high/high/high/high, high/high/high/low, high/high/low/low, high/low/low/low, high/low/low/high, high/low/high/high, low/high/high/high, low/high/high/low, low/high/low/low, low/low/low/low, low/low/low/high, low/low/high/high, high/low/high/low, and low/high/low/high.

Computing system 210 may utilize neuro-social relationship variables. These variables may be assigned to an individual via the aforementioned algorithm embedded within matching module 300 in response to user input 250 accepted by the computing system 210. Individuals form neuro-social relationships with one another based on personality needs of individuals. Needs may be defined as “high” and “low.” Some partners have high needs and others have low needs based on personality differences. Embodiments may provide a model of the formation and existence of neuro-social relationships based on personality needs of individuals. The model may allow individuals to understand their needs in a relationship and intentionally adapt to the needs of their partner. The model may further identify which needs are not being met that inevitably causes unhappiness and dissatisfaction in the relationship. The neurohormone Oxytocin is the basis for bonding and satisfaction in these relationships. It is produced naturally in the body when needs are fulfilled.

Individuals, along with the relationships they form, are defined by their needs; by whether they're high or low relative to the partners they choose to interact with in life, in love, in business, etc. Success in any interaction is then limited by their ability to choose similar partners, to cherry-pick complementary partners, or at least partners willing and able to LEARN what they and we need individually from the partnership. High-ness or low-ness comes into play and determines whether a partner can provide what you need in the long term. But an individual's tolerance for a partner's differences also determines whether the individual's personality is more likely to affect the final outcome.

The model may embody neuroscientific and psychometric principles that reveal an individual's personality type and needs. In embodiments, the model may be applied to marriages, the way an individual does business, the way an individual forms relationships, how individuals interact with their children, and even the way individuals vote or choose careers.

The model may further embody principles proposing the use of two different personalities to interact: a social and a relational personality that affects an individual's choices in life, sometimes unknowingly. The social personality is what may be used for all social interactions, including dating. The relational personality is what may emerge once we're in a committed relationship, which often is different and incompatible. Social personality is responsible for how individuals interact at work, at church, and in any other social setting. The problem is that individuals also date and marry based on our social personality. There is now an abundance of research that shows that individuals reserve civility not for our loved ones and those closest to them but to strangers and mere acquaintances.

The social personality is responsible for the persona or mask that individuals put on when they're in a social setting or trying to impress a date. The purpose is to help them achieve their goals in getting a job or person that they want and not necessarily who they need or who is best suited for them. To add more complexity to the mix, there are also dating hormones that blind them to the faults of the other person. So, the cliché, “love is blind”, may actually be true. Unfortunately, social personality often tricks individuals into committing to a relationship that their relational personality cannot sustain. Opposites attract, but they seldom connect to make the best partners in relationships. This is because attraction is not the same as connection. Once social personality goes away (because these hormones cannot remain effective forever), the relational personality kicks in and it is often heard that the person someone dated is not the one they felt they were married to.

The relational personality is what emerges once an individual is in a committed relationship, which is often different and incompatible. Within the relational personality, there may exist two pillars or basic connectors: high/low communication and high/low intimacy, which determine how much of each a partner needs to feel close and bonded in their relationship. Some partners have high needs and others have low needs based on personality differences. This personality difference is the primary hindrance to bonding and resolving conflict unbeknownst to couples.

To help to facilitate bonding or closeness, it is not just a couples' interaction style, but how much or how little a partner actually requires and how meeting those needs produces hormones such as Oxytocin. The amount of communication and intimacy needed and received in the relationship is what affects satisfaction more than anything else. When the needs of a partner are not met, there is little to no Oxytocin flow, which causes distance and conflict in the relationship. For some couples, it's important that their partner asks how their day was, because something as simple as that facilitates bonding. While ironically for others, one partner needs space in the relationship to stay bonded. One partner may be very private while the other has the need to share what may seem to be too much, giving the impression of neediness. The behaviors may actually be predicted in couples based on their personality types before any interaction occurs.

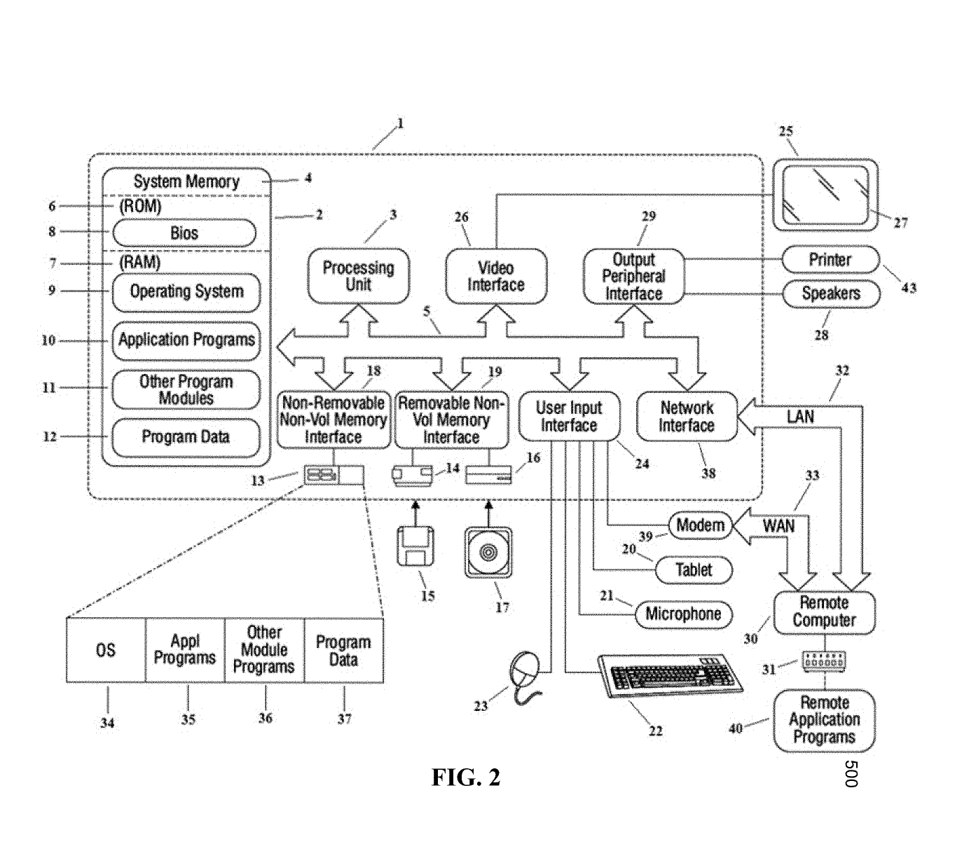

FIG. 2 displays a computing system and related peripherals that may operate with the psychometric instrument system, apparatuses and method, and system, apparatuses, and method using the same in accordance with embodiments.

With reference to FIG. 2, an exemplary system within a computing environment for implementing the disclosure includes a general purpose computing device in the form of a computing system 1, commercially available from, for example, Intel, IBM, AMD, Motorola, Cyrix, etc. Components of the computing system 2 may include, but are not limited to, a processing unit 3, a system memory 4, and a system bus 5 that couples various system components including the system memory 4 to the processing unit 3. The system bus 5 may be any of several types of bus structures including a memory bus or memory controller, a peripheral bus, or a local bus using any of a variety of bus architectures.

Computing system 1 typically includes a variety of computer readable media. Computer readable media can be any available media that can be accessed by the computing system 1 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 1.

The system memory 4 includes computer storage media in the form of volatile and/or nonvolatile memory such as read only memory (ROM) 6 and random access memory (RAM) 7. A basic input/output system (BIOS) 8, containing the basic routines that help to transfer information between elements within computing system 1, such as during start-up, is typically stored in ROM 6. RAM 7 typically contains data and/or program modules that are immediately accessible to and/or presently being operated on by processing unit 3. By way of example, and not limitation, an operating system 9, application programs 10, other program modules 11, and program data 12 are shown.

Computing system 1 may also include other removable/non-removable, volatile/nonvolatile computer storage media. By way of example only, a hard disk drive 13 that reads from or writes to non-removable, nonvolatile magnetic media, a magnetic disk drive 14 that reads from or writes to a removable, nonvolatile magnetic disk 15, and an optical disk drive 16 that reads from or writes to a removable, nonvolatile optical disk 17 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 13 is typically connected to the system bus 5 through a non-removable memory interface such as interface 18, and magnetic disk drive 14 and optical disk drive 16 are typically connected to the system bus 5 by a removable memory interface, such as interface 19.

The drives and their associated computer storage media, discussed above, provide storage of computer readable instructions, data structures, program modules and other data for the computing system 1. For example, hard disk drive 13 is illustrated as storing operating system 34, application programs 35, other program modules 36, and program data 37. Note that these components can either be the same as or different from operating system 9, application programs 10, other program modules 11, and program data 12. Operating system 34, application programs 35, other program modules 36, and program data 37 are given different numbers here to illustrate that, at a minimum, they are different copies.

A user may enter commands and information into the computing system 1 through input devices such as a tablet, or electronic digitizer, 20, a microphone 21, a keyboard 22, and pointing device 23, commonly referred to as a mouse, trackball, or touch pad. These and other input devices are often connected to the processing unit 3 through a user input interface 24 that is coupled to the system bus 5, but may be connected by other interface and bus structures, such as a parallel port, game port or a universal serial bus (USB).

A monitor 25 or other type of display device is also connected to the system bus 5 via an interface, such as a video interface 26. The monitor 25 may also be integrated with a touch-screen panel 27 or the like. Note that the monitor and/or touch screen panel can be physically coupled to a housing in which the computing system 1 is incorporated, such as in a tablet-type personal computer. In addition, computers such as the computing system 1 may also include other peripheral output devices such as speakers 28 and printer 43, which may be connected through an output peripheral interface 29 or the like.

Computing system 1 may operate in a networked environment using logical connections to one or more remote computers, such as a remote computing system 30. The remote computing system 30 may be a personal computer (including, but not limited to, mobile electronic devices), a server, a router, a network PC, a peer device or other common network node, and typically includes many or all of the elements described above relative to the computing system 1, although only a memory storage device 31 has been illustrated. The logical connections depicted include a local area network (LAN) 32 connecting through network interface 38 and a wide area network (WAN) 33 connecting via modem 39, but may also include other networks. Such networking environments are commonplace in offices, enterprise-wide computer networks, intranets, and the Internet.

For example, in the present embodiment, the computer system 1 may comprise the source machine from which data is being generated/transmitted and the remote computing system 30 may comprise the destination machine. Note however that source and destination machines need not be connected by a network or any other means, but instead, data may be transferred via any media capable of being written by the source platform and read by the destination platform or platforms.

In another example, in the present embodiment, the remote computing system 30 may comprise the source machine from which data is being generated/transmitted and the computer system 1 may comprise the destination machine.

In a further embodiment, in the present disclosure, the computing system 1 may comprise both a source machine from which data is being generated/transmitted and a destination machine and the remote computing system 30 may also comprise both a source machine from which data is being generated/transmitted and a destination machine.

Referring to FIG. 2, for the purposes of this disclosure, it will be appreciated that remote computer 30 may include any suitable terms such as, but not limited to “device”, “processor based mobile device”, “mobile device”, “electronic device”, “processor based mobile electronic device”, “mobile electronic device”, “wireless electronic device”, “location-capable wireless device,” and “remote device” including a smart phone or tablet computer.

The central processor operating pursuant to operating system software such as, but not limited to Apple IOS®, Google Android®, IBM OS/2®, Linux® UNIX®, Microsoft Windows®, Apple Mac OSX®, and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation, and algorithm generation. The provided functionality may be embodied directly in hardware, in a software module executed by a processor, or in any combination of the two.

Furthermore, software operations may be executed, in part or wholly, by one or more servers or a client's system, via hardware, software module, or any combination of the two. A software module (program or executable) may reside in RAM memory, flash memory, ROM memory, EPROM memory, EEPROM memory, registers, hard disk, a removable disk, a CD-ROM, DVD, optical disk, or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

The detailed description set forth herein in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

Disclosed subject matter relates to the operation of a matching service for individuals based primarily on their relational and neuro-social personality. Specifically, the disclosed subject matter uses a number of matching intelligence and personality tests to determine if two individuals are compatible and what differences they may have that may affect long-term happiness and stability in the relationship. The present disclosed subject matter matches individuals professionally, personally and relationally; this includes, but is not limited to: matching singles with other singles, analyzing couples' compatibilities and differences as well as unspoken needs; matching individuals with a study buddy or helping businesses who wish to improve hiring processes, sales, and productivity, using the present disclosed subject matter to match employees.

There are a number of matching services in both the personal and public arenas. Some of these services seek to match individuals romantically. While other services match prospective employees to employers. The present disclosed subject matter combines both services on one website for user's convenience.

The techniques utilized by dating and matchmaking services typically focus on superficial lifestyle variables, such as a person's preferences, like going to the beach or the movies, or their appearance or height. Such variables are referenced herein as social personality variables or superficial variables. In accordance with disclosed subject matter, superficial variables are not reliable to determine relational compatibility between two individuals or whether two individuals are compatible enough, for example, to sustain a long-term healthy relationship. In accordance with disclosed subject matter, superficial variables may be of limited value for addressing or predicting aspects of social compatibility or superficial compatibility between two individuals.

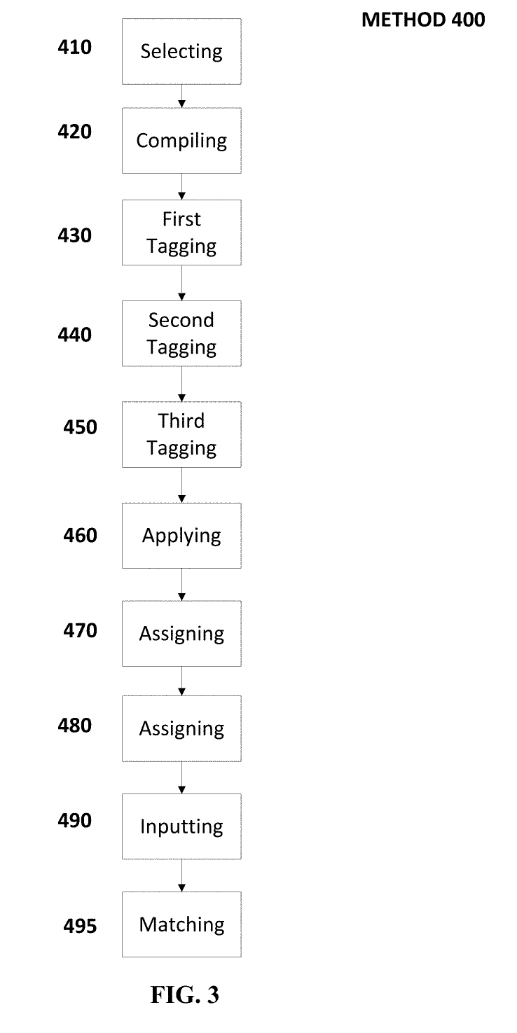

FIG. 3 displays a method for assigning personality types to an individual in accordance with embodiments. Method 400 may be utilized in conjunction with system 200. Method 400 may comprise selecting 410, via an individual, a personality test that the individual would like to take. The selection may be detected by system 200 and, in response, system 200 may compile 420 a list of questions that may be asked. The system 200 may then tag 430 a personality type to each question, tag 440 a category to each question, and tag 450 a level to each question. This may allow for proper scoring and designation of a personality type by system 200. A first, second, third, fourth, and fifth categorizing and level ascribing algorithm may be applied 460 to the questions that may be answered in the previous step. Another algorithm may then assign 470 a personality type and assign a level 480 to the individual taking the test. Consumer data may then be input 490 into the system 200. Results from the algorithm may be utilized to match 495 offered services and products to the personality type and level of the individual.

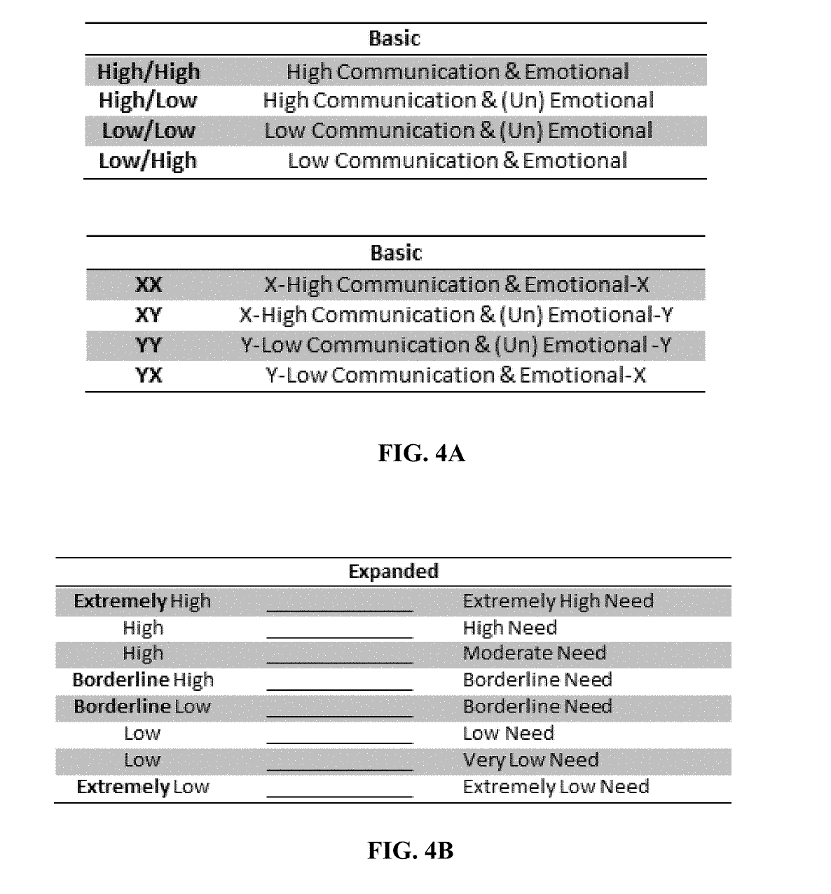

FIG. 4A is a tabular illustration showing structure and contents of an empirical database generated from selected answers to exemplary questions in an embodiment. Once an individual inputs data in the form of answers to the questions supplied to the individual by the system, the individual may be assigned a specific dual variable representing communication and intimacy of the individual. In embodiments, the individual may be assigned one of four dual variables that may be stored within the memory of the system 210.

The four dual variables may be, in embodiments, high/high, high/low, low/low, and low/high. In embodiments, a first high within a dual variable may conclude that an individual may be a high communicator. In embodiments, a first low within a dual variable may conclude that an individual may be a low communicator. In embodiments, a second high within a dual variable may conclude that an individual may be emotional or have high intimacy needs. In embodiments, a second low within a dual variable may conclude that an individual may be (un)emotional or have low intimacy needs. So, for example, a person assigned a high/high dual variable may be a high communicator and more emotional. A person assigned a high/low dual variable may be a high communicator and unemotional. A person assigned a low/low dual variable may be a low communicator and unemotional. A person assigned a low/high dual variable may be a low communicator and more emotional.

FIG. 4B is a tabular illustration showing structure and contents of an empirical database generated from selected answers to exemplary questions in an embodiment. The dual variables above may be further broken down to further embody communication, intimacy, adaptability, interactivity, and social compatibility. The dual variables may range from extremely high need to extremely low need of the individual.

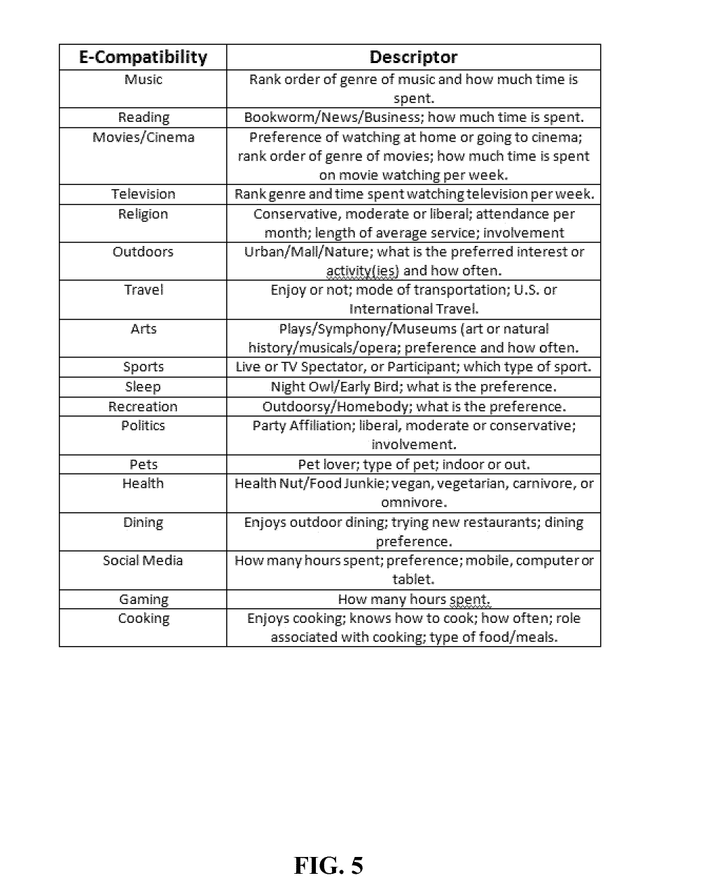

FIG. 5 is a representative listing of social compatibility categories assessed, and individual preferences in the same, that may be used in an embodiment. The listing may show examples of different activities in which an individual may partake. These may include, but are not limited to music, reading, movies/cinema, television, religion, outdoors, travel, arts, sports, sleep, recreation, politics, pets, health, dining, social media, gaming, and cooking. Based on an individual's dual variable, the individual may be classified within each activity. In embodiments, the system may provide questions that may require input from an individual in order to draw conclusions about the different activities.

For example, in order to classify an individual for music, an individual may be asked to provide a ranking order of genres of music and how much time is spent listening to each genre. For reading, an individual may, for example, be asked what they prefer to read, out of novels, news articles, and business articles and/or how much time they spend on the certain reading. For television, an individual may, for example, be asked to rank television genres and/or the amount of time spent watching television per week. For religion, an individual may, for example, be asked to identify themselves as conservative, moderate, or liberal. The individual may further be asked to supply an amount of attendance of church per month, a length of the average service attended, and/or how involved the individual is concerning church. For outdoors, an individual may, for example, be asked to supply whether the individual prefers urban areas, shopping areas, or natural areas. The individual may further be asked to supply preferred interests or activities and how often the individual partakes in these interests or activities. For arts, an individual may, for example, be asked to supply whether the individual prefers plays, symphonies, museums, or all of the above. The individual may further be asked to supply how often the individual partakes in these activities. For sports, an individual may, for example, be asked to supply whether the individual prefers live sports, sports on the television, or both. The individual may further be asked to supply which sports the individual prefers, or if they participate in said sports. For sleep, an individual may, for example, be asked to supply whether the individual is a night owl or an early bird. For recreation, an individual may, for example, be asked to supply whether the individual is outdoorsy or a homebody. For politics, an individual may, for example, be asked to supply a party affiliation (liberal, moderate, or conservative). The individual may further be asked to supply whether the individual is directly involved in politics. For pets, an individual may, for example, be asked to supply whether the individual is a pet lover. The individual may further be asked to supply what type of pet the individual prefers and/or whether the individual prefers an indoor or an outdoor pet. For health, an individual may, for example, be asked to supply whether the individual is a health nut, a food junkie, a vegan, a vegetarian, a carnivore, an omnivore, or more than one option. For dining, an individual may, for example, be asked to supply whether the individual prefers at least one of outdoor dining and trying new restaurants. The individual may further be asked to supply their dining preferences. For social media, an individual may, for example, be asked how many hours an individual spends on social media, what the individual's preference is (such as type of social media). The individual may further be asked to supply whether the individual prefers to view social media on a mobile device, a computer, or a tablet. For gaming, an individual may, for example, be asked to supply how many hours the individual spends on gaming. For cooking, an individual may, for example, be asked to supply whether the individual enjoys cooking and whether the individual knows how to cook. The individual may further be asked how often the individual cooks, the role associated with cooking, and the type of food/meals cooked by the individual.

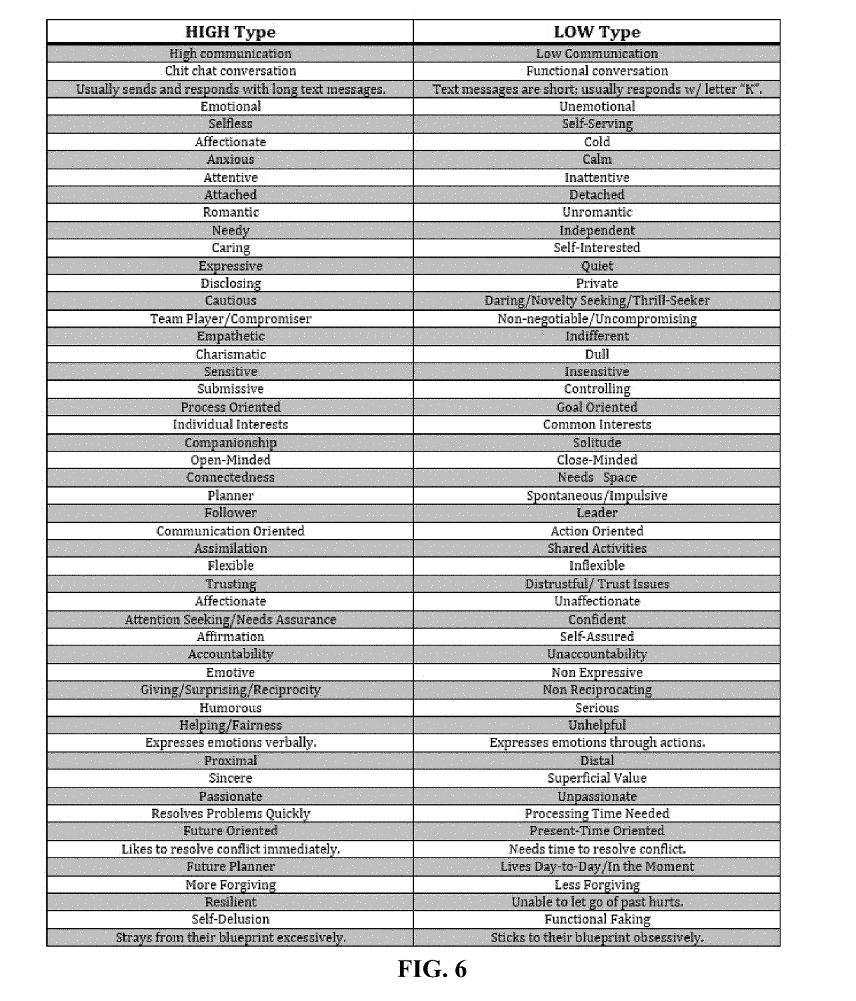

FIG. 6 is a representative listing of dichotomous personality traits that may be identified and used in an embodiment. In embodiments, the high in the dual variable may correlate with traits such as, but not limited to high communication, chit chat conversation, usually sends and responds with long text messages, emotional, selfless, anxious, attentive, attached, romantic, needy, caring, expressive, disclosing, cautious, team player/compromiser, empathetic, charismatic, sensitive, submissive, process oriented, individual interests, companionship, open-minded, connectedness, planner, follower, communication oriented, assimilation, flexible, trusting, affectionate, attention seeking/needs assurance, affirmation, accountability, emotive, giving, surprising, reciprocity, humorous, helping, fairness, expresses emotions verbally, proximal, sincere, passionate, resolves problems quickly, future oriented, likes to resolve conflict immediately, future planner, more forgiving, resilient, self-delusion, and strays from their blueprint excessively. In embodiments, the low in the dual variable may correlate with traits such as, but not limited to low communication, functional conversation, text messages are short and usually responds with the letter “K”, unemotional, self-serving, calm, inattentive, detached, unromantic, independent, self-interested, quiet, private, daring, novelty seeking, thrill seeker, non-negotiable, uncompromising, indifferent, dull, insensitive, controlling, goal oriented, common interests, solitude, close-minded, needs space, spontaneous, impulsive, leader, action oriented, shared activities, inflexible, distrustful, trust issues, unaffectionate, confident, self-assured, unaccountability, non-expressive, non-reciprocating, serious, unhelpful, distal, superficial value, unpassionate, processing time needed, present-time oriented, needs time to resolve conflict, lives day-to-day, in the moment, less forgiving, unable to let go of past hurts, functional faking, and sticks to their blueprint obsessively. Once input has been received by the system, the system may associate at least one of the above traits based on the input.

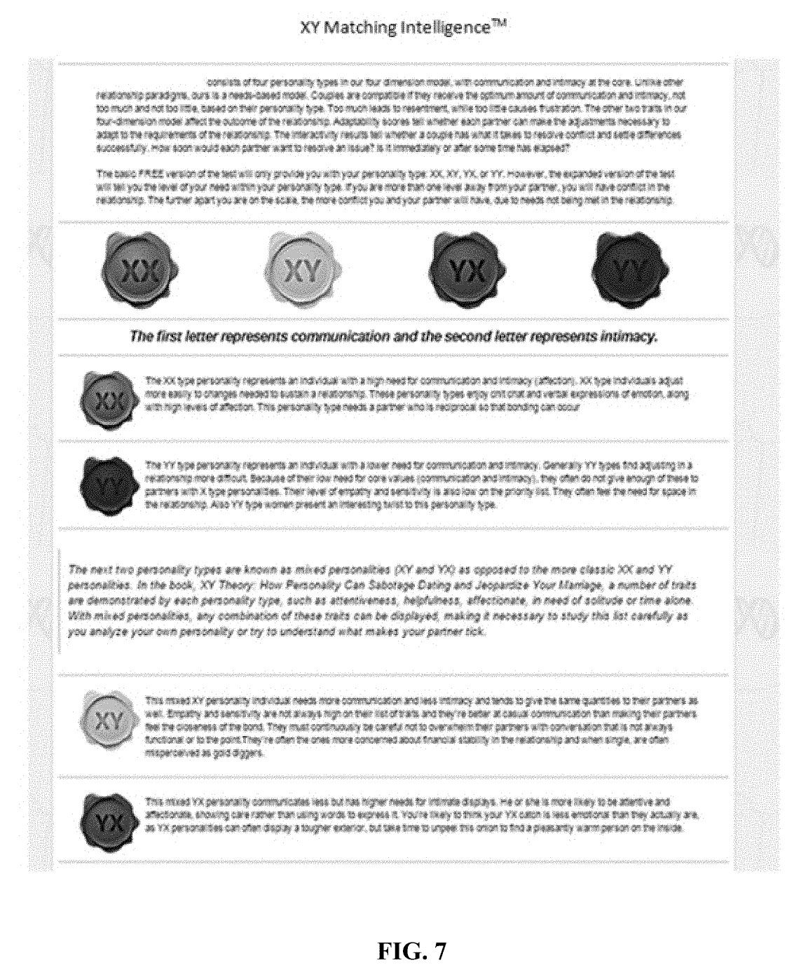

FIG. 7 is an illustrative description of four binary personality types generated from selected answers to exemplary questions in an embodiment. For the purposes of this disclosure, the term “dual variable” and “type personality” may be synonymous. In embodiments, the high/high type personality represents an individual with a high need for communication and intimacy (affection). High/high type individuals adjust more easily to changes needed to sustain a relationship. These personality types enjoy chit chat and verbal expressions of emotion, along with high levels of affection. This personality type needs a partner who is reciprocal so that bonding can occur.

The low/low type personality represents an individual with a lower need for communication and intimacy. Generally low/low types find adjusting in a relationship more difficult. Because of their low need for core values (communication and intimacy), they often do not give enough of these to partners with high type personalities. Their level of empathy and sensitivity is also low on the priority list. They often feel the need for space in the relationship. Also low/low type women present an interesting twist to this personality type.

This mixed high/low personality individual needs more communication and less intimacy and tends to give the same quantities to their partners as well. Empathy and sensitivity are not always high on their list of traits and they're better at casual communication than making their partners feel the closeness of the bond. They must continuously be careful not to overwhelm their partners with conversation that is not always functional or to the point. They're often the ones more concerned about financial stability in the relationship and when single, are often misperceived as gold diggers.

This mixed low/high personality communicates less but has higher needs for intimate displays. He or she is more likely to be attentive and affectionate, showing care rather than using words to express it. You're likely to think your low/high catch is less emotional than they actually are, as low/high personalities can often display a tougher exterior, but take time to unpeel this onion to find a pleasantly warm person on the inside.

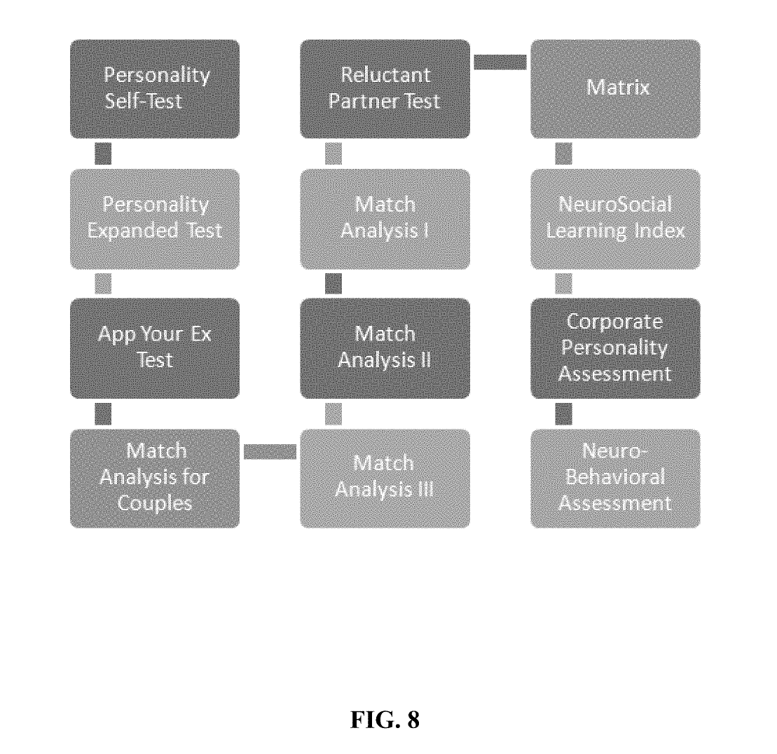

FIG. 8 is an exemplary listing of binary matching tests that may be selectable by individuals and used in an embodiment. The binary matching tests may be implemented by the system in order to provide interactive tests to individuals via a user interface. In embodiments, the tests may include, but are not limited to a high/low personality self-test, a high/low personality expanded test, an app your ex test, a high/low Neuro-Social Personality test, a high/low match analysis III, a high/low match analysis II, a high/low match analysis I for Couples, a high/low reluctant partner test, a high/low matrix, a neuro-social learning index, a corporate personality assessment, and a neurobehavioral assessment.

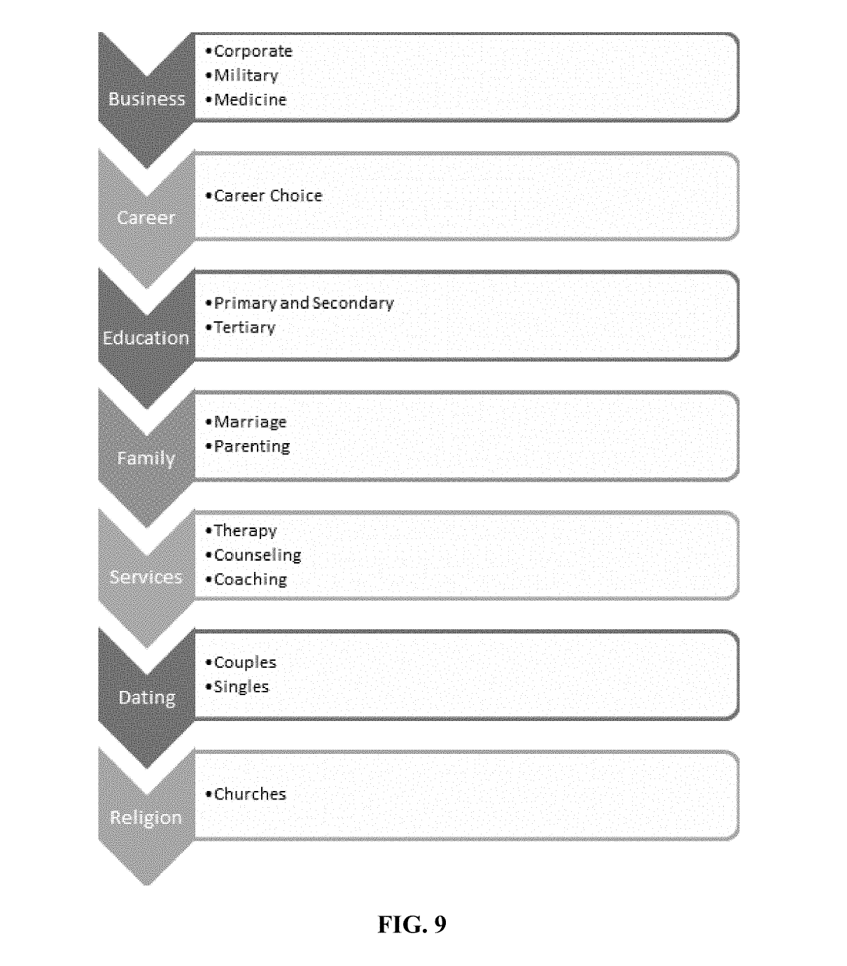

FIG. 9 is an exemplary listing of disciplines that may be utilized by the system for analyzing current and/or future relationships in an embodiment. The disciplines that the system may use to match relationships may include, but are not limited to business, career, education, family, services, dating, and religion. Business may include corporate, military, and medicine relationships. Career may include career choice relationships. Education may include primary, secondary, and tertiary education relationships. Family may include marriage and parenting relationships. Services may include therapy, counseling, and coaching relationships. Dating may include couples and singles relationships. Religion may include church relationships.

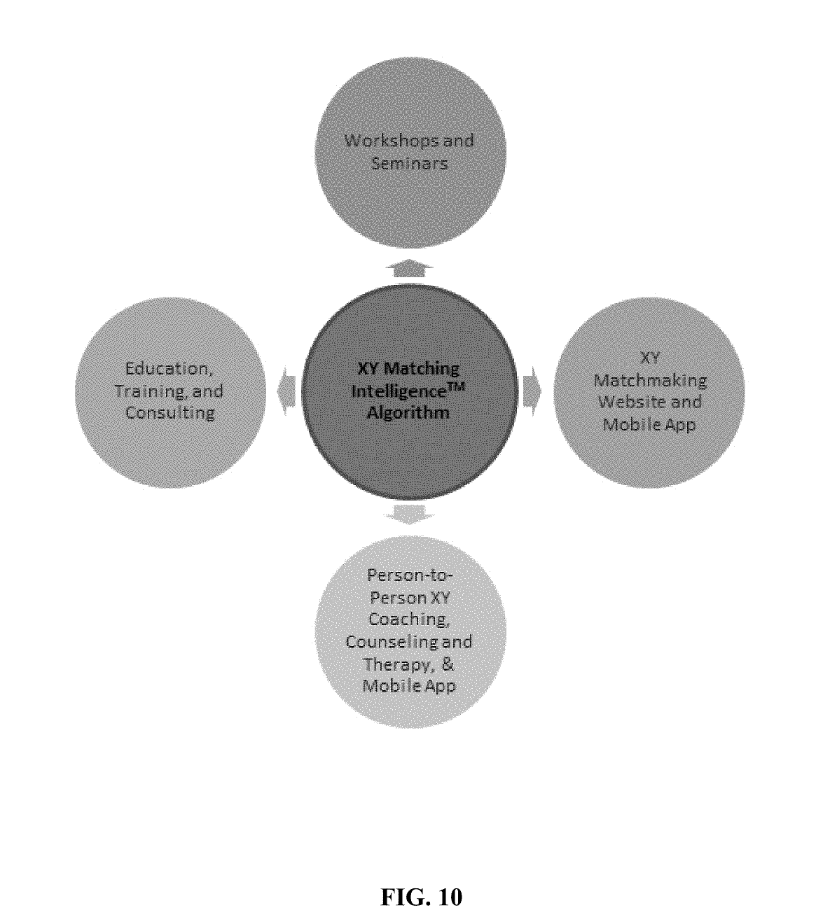

FIG. 10 is an exemplary listing of platform applications that may provide offerings of products, services or both in relation to the system for analyzing current and/or future relationships, in an embodiment. An algorithm within the system may provide information to a number of applications that may be encompassed within the system or may be linked to the system. In embodiments, the applications may include, but are not limited to a workshops and seminars application, an education, training, and consulting application, a person-to-person high/low coaching, counseling, and therapy application, and a high/low matchmaking website and application.

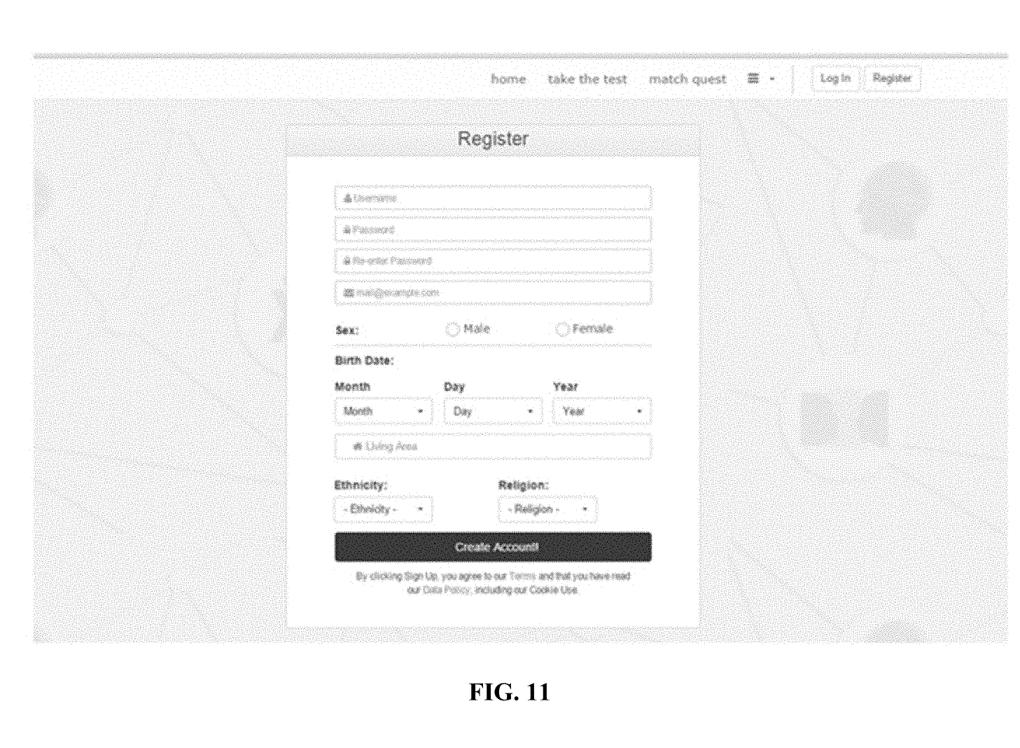

FIG. 11 is a view of a displayed registration page in an embodiment. The registration page may allow a user to create an account for a matching service. Information that a use may provide on the user interface may include, but is not limited to a username, a password, an email, a gender, a date of birth, an address, an ethnicity, and a religion. At least some of this information may be utilized by the algorithm of the system for analyzing current and/or future relationships in order to more properly provide beneficial matching results to the user.

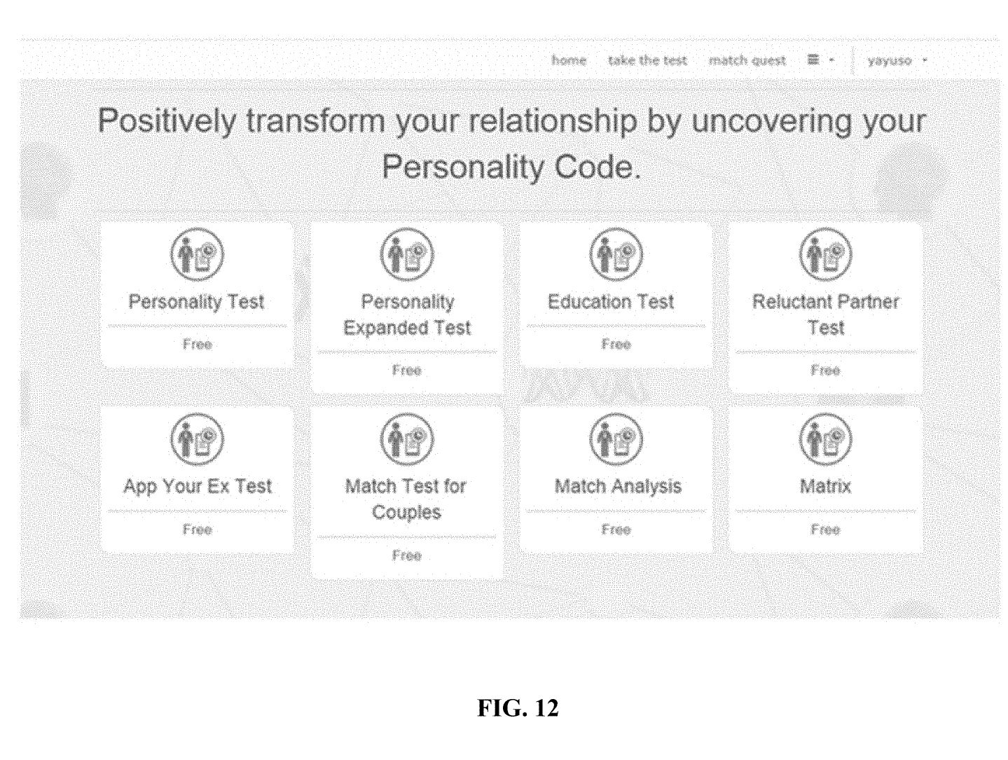

FIG. 12 is a view of an exemplary displayed listing of binary matching tests that may be selected and used in an embodiment. In embodiments, a user may choose, via the user interface, at least one of a personality test, a personality expanded test, an education test, a reluctant partner test, an app your ex test, a match test for couples, a match analysis, and a matrix test.

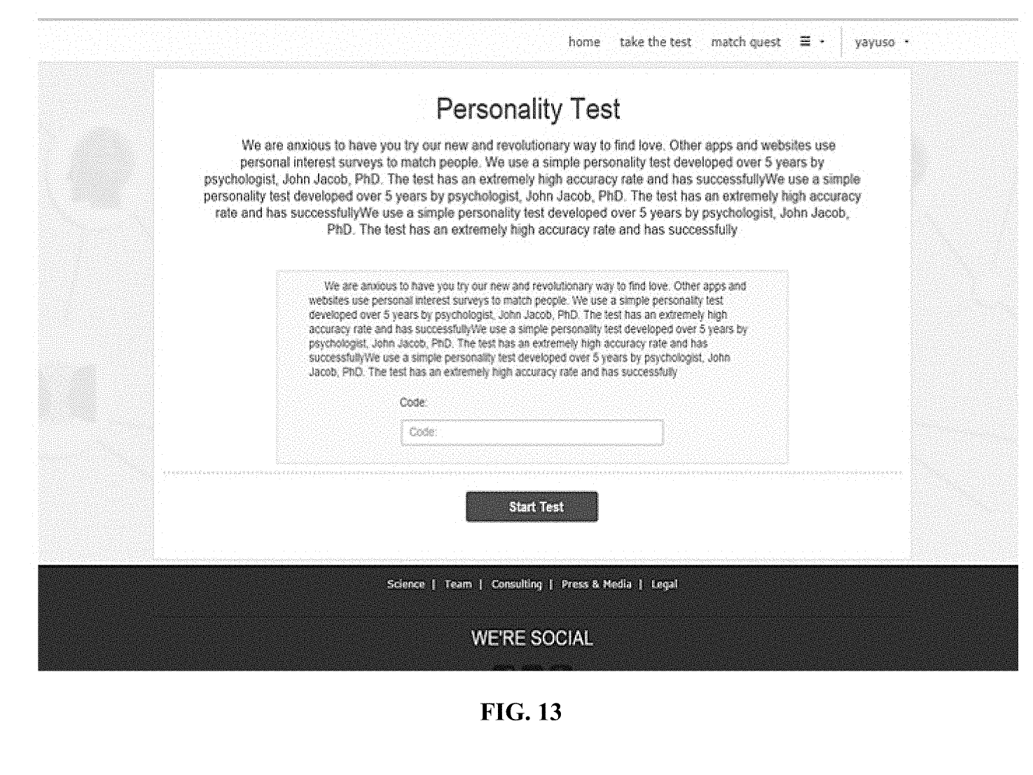

FIG. 13 is a view of an exemplary displayed start page in an embodiment. The start page may comprise a description of what one or more tests may provide to the user. An engageable code section may be displayed that may allow the user to input a code relating to personality matching tests or some other category or classification for matching. An engageable icon may allow the user to start a personality matching test once the user engages the engageable icon.

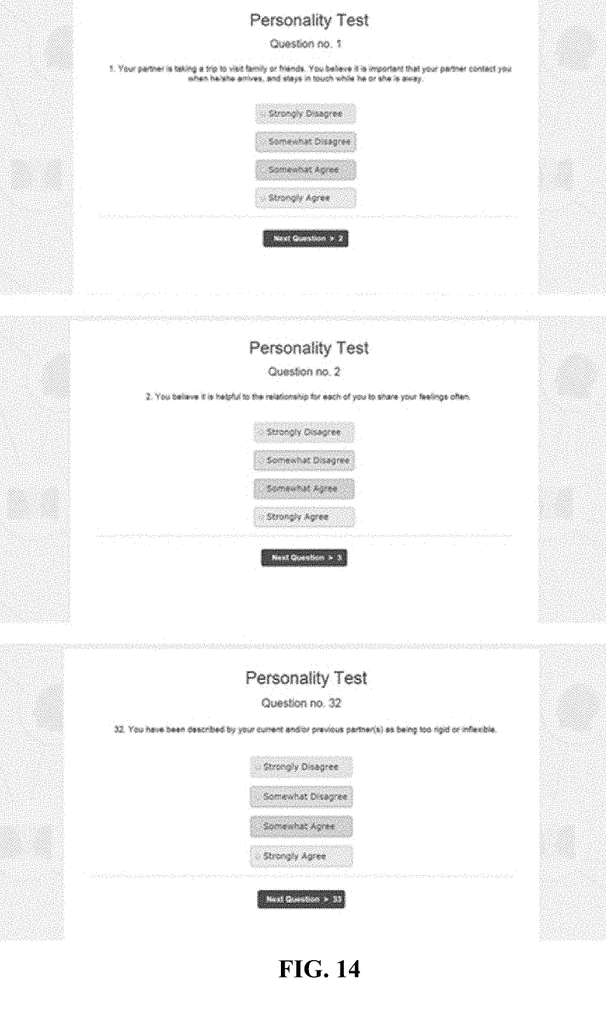

FIG. 14 is an exemplary listing of questions in an embodiment. An exemplary listing of questions as set forth in FIG. 14 may be used, for example, with answers provided by numerous individuals to determine compatibility and differences in personal relationships based on the individual's personality type, including, but not limited to: it assesses relationship compatibility, and highlights areas of significant differences that reveal what couples (married or dating) need to work on in the relationship; for singles, it may identify an individual's relationship and social personality, as well as what they need from a potential mate; for parenting, the test may provide an analysis of the bond between the parent and child, and highlight personality differences that might impair the parent-child interaction. In embodiments, answers may be in the form of scaled answers that may show how strongly a user may agree or disagree with a question.

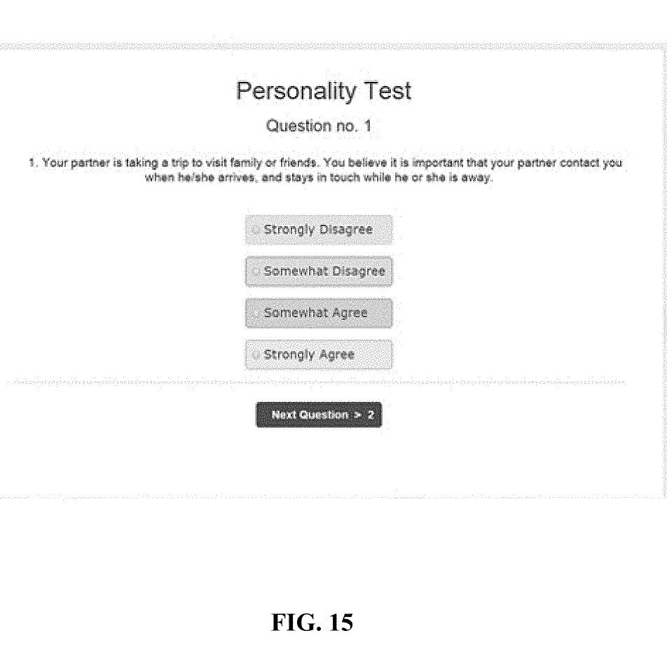

FIG. 15 is an exemplary listing of questions in an embodiment that may be utilized, for example, to inform professional decisions relating to individuals. An exemplary listing of questions as set forth in FIG. 15 may be used, for example, to be answered by numerous individuals and for matching individuals professionally, including, but not limited to: prospective employees to positions that correspond with their personality type, to match current employees to positions that may help increase and improve productivity, to best predict customer behavior for increasing sales, for team building and determining which personality types work best with various managers, predicting which soldiers would be less susceptible to PTSD when certain combat tours are anticipated, and decrease malpractice lawsuits by improving doctor-patient relationships.

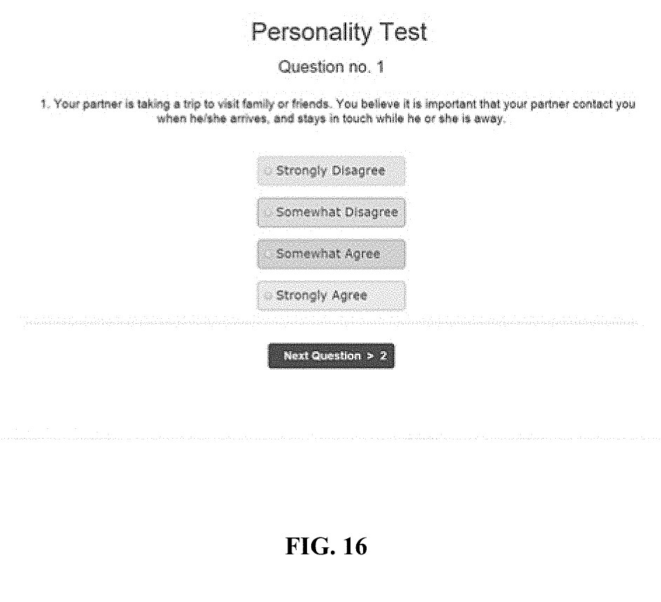

FIG. 16 is an exemplary listing of questions in an embodiment that may be utilized, for example, to inform educational decisions relating to individuals. An exemplary listing of questions as set forth in FIG. 16 may be used, for example, to be answered by numerous individuals and for matching individuals educationally, including, but not limited to: helping improve teacher and student relationships and to facilitate academic achievement; improving student-peer interaction by using the present disclosed subject matter to help students identify classmates with whom they have a better connection.

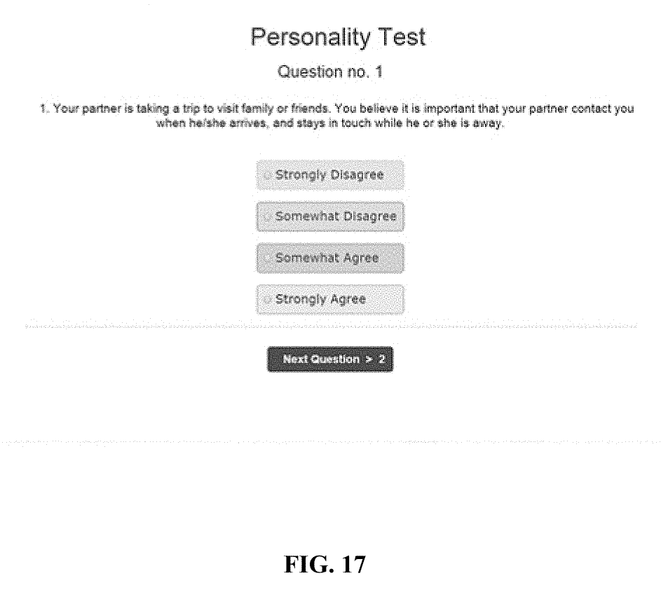

FIG. 17 is an exemplary listing of questions in an embodiment that may be utilized, for example, to inform career decisions relating to individuals such as students. An exemplary listing of questions as set forth in FIG. 16 may be used, for example, with answers provided by numerous individuals, such as students, for matching the individuals to careers compatible with their determined personality type.

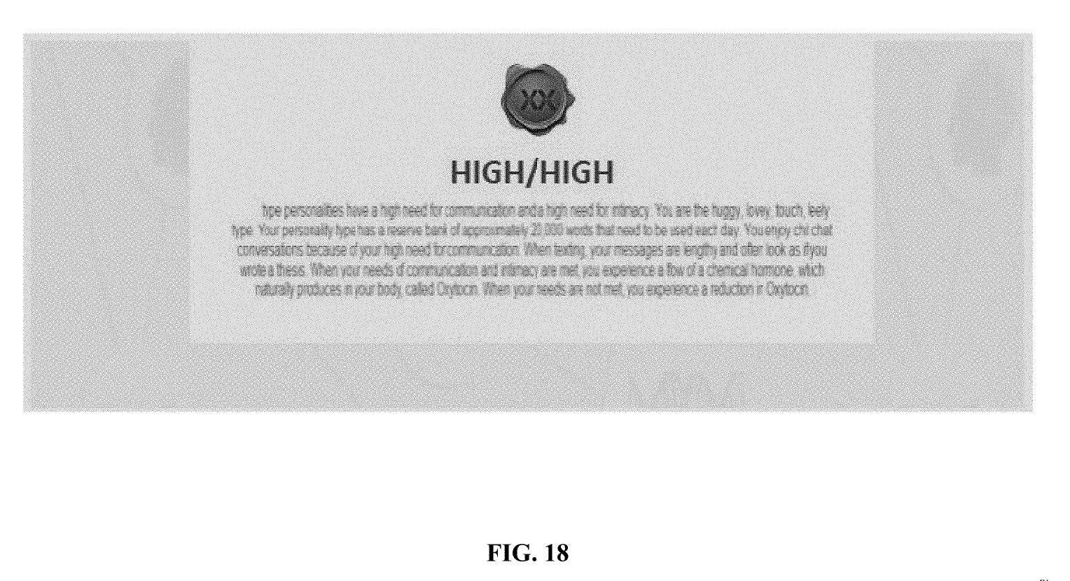

FIG. 18 is a composite image including a photographic depiction of an individual and a representation of a binary personality model assigned in an exemplary embodiment. The image may show a specific personality type that may have been assigned to a user after a user had taken a personality test. The image may further show a description of the specific personality type. The image is referred to as a personality tag that can be attached to an individual's image/photo.

Disclosed subject matter may determine if individuals have a basic connection with each other, based on needs and differences in their personality. Users may complete one of many personality tests at the start, after they complete their profile. Once the test is completed, the results of the tests are revealed. For the basic test, a user may be given results for the two core categories of communication and intimacy. There may be four personality codes on the scale that are given: high/high, high/low, low/low, and low/high. For the expanded version, users may be given a level that corresponds with each high or low. This may range from extremely high need to extremely low need which comprise the personality code. The results of a user's personality type may be stored in the database. The present disclosed subject matter may match individuals who have the highest compatibility or satisfaction scores with the most compatible presented first. For singles, these individuals can thereby find a partner for the following reasons: romance, friendship, companionship, a study buddy (college) or a business contact. The present disclosed subject matter may expose individuals to various products, such as: workshops, coaching, books and training that can help improve an individual's dating experience or the best places to meet a match. This may be referred to as dating intelligence. The present disclosed subject matter's algorithm may be used to provide a platform, the dating website and dating mobile apps to match singles based on their personality type. Singles may download apps and create a profile to meet compatible matches in a variety of unique ways. The website and app's personality tests may assist singles to increase their matching pool and take the experience using the present disclosed subject matter.

Couples may use the present disclosed subject matter to complete a match analysis to discover commonalities and differences, as well as unspoken needs that affect the relationship. The present disclosed subject matter may be used to create a chat room where couples and partners can go to one of four rooms to chat with similar personality types to gain better understanding of their partner's personality type. In order to remediate the problems in the relationship or marriage, the present disclosed subject matter may connect couples to coaches and therapists who are trained and certified as XY Coaches and Therapists. The present disclosed subject matter may be used as a foundation for mobile apps that can help improve relationships. The present disclosed subject matter may expose couples to various products, such as: workshops, coaching, books and training that can help improve relationships.

The present disclosed subject matter may provide services for business via consultation regarding how businesses hire individuals, how the best teams are formed, how to increase sales by understanding the personality of their clients and customers. The present disclosed subject matter may for instance analyze which soldiers in the military would be less susceptible to PTSD when certain combat tours are anticipated, and in the medical field, can decrease malpractice lawsuits by improving doctor-patient relationships. These may be done through seminars, workshops, in-services, training, assessment, and API licensing using the present disclosed subject matter.

In embodiments, the present disclosed subject matter may match students to careers that match their personality type, thereby increasing job satisfaction and productivity.

In embodiments, the present disclosed subject matter may match individuals educationally, including, but not limited to: helping improve teacher and student relationships and to facilitate academic achievement; improving student-peer interaction by using the present disclosed subject matter to help students identify classmates with whom they have a better connection.

Disclosed subject matter may include a matchmaking service and system that seeks to connect individuals both socially and relationally based on the user's personality type to connect with other individuals in like manner. The website provides a platform that uses a matching algorithm to match individuals based on the user's personality type. The system uses personality matching tests to gather information that may allow the website to correlate a user's parameters for the type of person they're searching for as well as the type of connecting they're seeking. Categories may include: Romantic Relationships, Friendships, Sports, Study, and Business Connections. These proprietary tests may measure the extent to which individuals are dissimilar and whether these differences might jeopardize the connection, are used to power the analysis for all matches.

In embodiments, a series of tests can be used to help those already in relationships determine the quality of these relationships and whether adjustments need to be made to increase relationship satisfaction.

In an embodiment, a (phone or watch) app or wearable may allow couples to reset their relationship by reminding them of their partner's needs on a daily/weekly basis and prompting them to act on those needs. During conflict, a couple's apps or wearables will communicate with each other to alert a partner of the other partner's rising stress levels, so adjustments can be made to the interaction style. This will help to improve bonding and facilitate conflict resolution of high/low couples.

An embodiment may provide analysis for those who: seek to connect with others in non-romantic ways, are singles seeking the best possible romantic connection, and are couples already in a relationship but are seeking to improve or reset their relationship.

In an embodiment, a code feature may be available on the website and as a mobile app which may allow users to search for compatible partners among specific groups, like “universities” or churches, etc.

In an embodiment, a matchmaking service and system may be available on the website and as a mobile app that seeks to connect individuals both socially and relationally based on the user's personality type to connect with other individuals in like manner.

In an embodiment, a mapping feature may be available on the website and as mobile app which can be purchased on the website. The app may allow users to access partners with whom to match from anywhere in the world, regardless of how close or how far that individual might be from the user.

In an embodiment, an app may allow individuals to touch mobile phones together, or when in close proximity, the two phones may let users know that they are a match based on their personalities and the phone may automatically display the user's match. Their phones may analyze and exchange data to let users know the type of connection that they have. Results of the match may be displayed on both phones via animation form.

In an embodiment, an app add-on feature may allow your mobile device to vibrate to communicate the type of a match. This feature may match you with a number of connections you have with the other person to the number of times your phone vibrates. In other words, the more connections you have with that individual, the more times your phone may vibrate. It may also flash a light if you're in a dark area, such as a night club.

In an embodiment, an app may allow users to match themselves with users at a particular venue at any given time. Venues may include places such as concert halls, night clubs, and sporting events, such as the Los Angeles Forum or Madison Square Garden in New York.

In an embodiment, an app add-on feature may allow users to choose a specific event on a specific date and time to match users who may be attending the event to be able to attend together.

In an embodiment, an app may coordinate blind dates for users whose personality types are compatible. The app may additionally be used to assist with finding an event or location for dates.

In an embodiment, an app may use a speed dating format for mobile phones.

In an embodiment, a website feature may allow users to copy their pictures generated on the website, bearing the user's personality type, which may be referred to as a personality tag. User can choose to have the tag hidden, which may be referred to as a ghost tag. The individual can also take this tag with them to any website for social networking or otherwise.

A desktop and mobile app may connect users/couples if match analysis results show incompatibility, to coaches or therapists. The app may connect individuals to coaches that may help them to achieve a variety of goals from getting into a relationship, to finding a job that complements their personality type, or to helping a child past low achievement academically and achieve higher grades. An individual can be connected to a certified counselor or therapist for more intensive therapeutic needs.

In an embodiment, users of both the apps and website may be exposed to advertising.

MARRIAGE—Relationship needs and relationship personalities may determine needs that many people are unaware of. Using science, problems in a marriage may be predicted long before they even occur. Additionally, it can be found what couples need to do specifically to avoid relationship ending conflict. Basically, couples may be able to identify “blind spots” in their relationships. A couple's personality difference is a primary hindrance to bonding and resolving conflict. It has been learned that it's not one person's fault, but personality differences that are causing conflict in a relationship. Through a 12-step relationship management system, couples may learn how to meet their partner's needs by first understanding what their own needs are in the relationship. Once this is understood, couples can focus on mastering those needs to facilitate the hormone, Oxytocin that produces bonding in the relationship. The focus is not about an individual changing their core being, but simply making minor adjustments for maintaining a strong and harmonious relationship. When an individual falls in love, they initially fall in love with their fun loving, romantic, caring representative in a social setting, essentially stuck in “play” mode. Hormones help another individual to fall for this person without the serious considerations of work and family matters. Personality tests can help rediscover this individual and reset a relationship to increase satisfaction and enjoyment.

DATING INTELLIGENCE—Individuals may be able to determine how well matched they are, even before going on a first date. As such, matching personalities saves singles time and often disappointment from entering a potentially messy relationship. Disclosed methods and personality tests may measure the relational personality and not the social personality, as other test instruments do. In other words, the personality tests can tell an individual what a date may be like once in a committed relationship and whether or not he/she would be able to meet needs to keep the individual happy. This may be known before taking that first step. A test may examine 4 key areas of relationship personality: adaptability, interactivity, communication, and intimacy. Adaptability may refer to an individual's ability to make the adjustments needed from partners interested in making the relationship work. Interactivity, among other needs may refer to the need to successfully resolve conflict or differences when they occur. Communication is a core dimension or need that may refer to various forms of communication that may promote the flow of the neuro-hormone, Oxytocin which research identifies as essential for bonding or closeness. Intimacy is a second core dimension that may consist of a variety of traits that may differ between high and low type personalities but may also produce Oxytocin and facilitate bonding as well. And this is only the first or relational level of matching. On the second level, social traits may be examined, which are important because they too produce Oxytocin and represent the social arena in which most relationships begin.

PARENTING AND FAMILY RELATIONS—The disclosed methods and tests may help families deal with various types of conflict affected by personality differences. Parents whose personalities show a high/low difference may often have more conflict with children with opposing personalities. Building a bond varies by child; it is also easily facilitated or hindered by the personality of the parent compared to that of the child. Each child's personality type may interact differently, even among siblings. Some children like space and are not the “let me tell you what happened at school today” types, while others are the complete opposite. The disclosed methods and tests may help parents to connect with each child by teaching them about their children's personality differences. Some parents may seem to show clear preference for children with opposite personalities. The preference for children with similar personalities may often be flipped in young adulthood. Interestingly, low-type parents may be cautioned, on the verge of divorce, to set up arrangements that may allow them to stay in touch with their children after separation. High-type children may also seem to suffer more openly from the lack of or a breakdown in communication from feuding parents. A child's home environment may determine whether or not the child may be able to commit to or sustain a healthy relationship as adults.

EDUCATION—Students may not apply themselves in any class taught by a teacher they feel that they have no connection with. This may be particularly true in subject areas like math. When asked why a student is failing math, a student may often say, “I don't like the teacher.” When the disclosed methods and tests are applied to romantic relationships, it has been found that it's difficult to get partners to make the necessary changes for their partner if they don't feel a connection to or no longer respect them. It is not expected that personality differences play as big a role in whether a child learns academically, but it does. Suffice it to say here, though, an even greater impact may lie in the fact that teaching style and grading is often reliant on a child's participation in class and expressiveness, both verbally and in written form. But low-type children have less expressive personalities. Should a low-type child be penalized for being who they are naturally? A model may be created for educators to better connect with their students and improve learning processes based on the student's personality type.

CAREER—It may be known that individuals tend to prefer jobs that match their personality. If they are fortunate at the time they seek meaningful employment, they might choose a job or career that energizes us rather than depletes us at the end of the day. This may be shown when the disclosed methods and tests are applied. Low-type individuals were shown choosing careers that were requiring less interaction, more solo projects, and less team work. Engineering, computer programming, and similar careers may typically be the choice of low-type personalities, while high-types were often found in service oriented careers. When this did not occur, high-types felt their jobs weren't a vocation or calling, but drudgery, while misplaced low-types were going home to their families from jobs like teaching or counseling, and needing one to two hours to recharge their batteries and recoup before spending time with their families. The disclosed methods and tests may help students understand their own personalities and make career choices based on their personality type.

BUSINESS—Every facet of business may be affected by personality types of employees and clients. Sales may be affected by a customer's personality and, as a result, companies claiming to be able to provide businesses with an API or the algorithms to best predict customer behavior are numerous. Disclosed methods and personality tests may analyze employee behavior and thereby boost productivity, and predict which individuals may best form synergistic teams. Hiring and firing practices have been discovered to be affected by the personality differences between individuals in HR conducting interviews and the interviewees. But, team building may be the biggest story when it comes to output (which personality types work best with their managers and which personality types should be aligned to perform which functions or positions to maximize productivity). Furthermore, employees who do not get relational needs met at home may be more apt to try to get needs met at work, which may lower productivity.

THERAPY, COUNSELING & COACHING—Applying the disclosed methods and tests to therapy and coaching may successfully impact marriages, dating, and education. Providing therapy and counseling to individuals, school counseling to students, and/or coaching for individuals with more short-term and goal-oriented needs may change when applying the disclosed methods and tests. New science available to clinicians, including growing disciplines, such as the Neuroscience of Psychotherapy and of Coaching continues to change. But change may be welcomed because, through no fault of clinicians, marital and family counseling does not have a high success rate because many individuals wait until they are at the throes of divorce or separation to consider seeking help. Often, at this point it is too late and both partners may no longer be “all-in”, or fully invested. The disclosed methods and tests may interrupt this by exposing fissures in the fabric long before they can be clearly seen, certainly before marital failure, which may help partners to clearly see this crisis looming so they can seek immediate help. When it comes to getting professional help, timing may be everything. It's less useful or helpful to seek professional help for a relationship when it has deteriorated to stage 4 (in a 5-stage model of deterioration). Additionally, in spite of the best efforts on the part of clinicians in getting clients to accept that they are part of a dynamic relationship, a system where one partner's actions affect the other often in a cyclical way which then assigns blame to either party may be difficult. This may be hindering to the process. By utilizing the disclosed methods and personality tests, this may not occur. After learning of a modality that cites partners' differences as the culprit, individuals may find it easier to accept a “no-fault” position when entering a client-clinician therapeutic relationship. The focus on the clients' ability to adapt and adjust, along with addressing the universal need for communication, intimacy, and resolution for conflict differences, may allow service providers to focus on goals that may allow these basic needs to be met quickly and successfully.

RELIGION—The divorce rate has been rising considerably among religious denominations over the past two decades. It has been determined that spirituality may not be the sole reason for the rise, but personality differences among people of faith that may be wreaking havoc on marriages. Religious belief does not replace the need for compatibility in a relationship nor personal adjustment and growth, once that relationship or marriage is embarked upon. The disclosed methods and tests may help individuals to understand their spiritual and relational compatibilities before entering into a relationship.

According to disclosed subject matter, a system may include primary variables which are not superficial variables. It will be understood that, as used herein, “primary variable” means primary relationship personality variables. According to disclosed subject matter, primary relationship personality variables may include the following: (a) need for communication, (b) need for intimacy, (c) interactivity (e.g., need for conflict resolution), and (d) adaptability (e.g., tolerance of differences). In an embodiment, primary relationship personality variables may be limited to the group of variables consisting of: (a) need for communication, (b) need for intimacy, (c) interactivity (e.g., need for conflict resolution), and (d) adaptability (e.g., tolerance of differences). According to disclosed subject matter, a system may include primary relationship personality variables that are sufficient for addressing complexity of variables that may be considered to determine compatibility between two individuals. According to disclosed subject matter, a system may include primary relationship personality variables that are sufficient for determining or predicting whether two individuals are sufficiently compatible for a healthy long-term relationship to be sustained between them. In some embodiments of disclosed subject matter, it may be considered that “compatibility” between individuals is sufficient where a personal relationship that may be characterized as healthy or normal exists for a long-term period. It will be understood that in some embodiments, for example, a long-term period may be a period of at least 8 years. In some embodiments, a system may include both primary relationship personality variables that are sufficient for addressing complexity in determining compatibility between two individuals, and also may include superficial variables that address less complex, limited aspects of compatibility between two individuals. According to disclosed subject matter, a method includes considering primary relationship personality variables which are not superficial variables. According to disclosed subject matter, a method may include considering primary relationship personality variables that are sufficient for addressing complexity that may be considered to determine compatibility between two individuals. According to disclosed subject matter, a method may include both considering primary relationship personality variables that are sufficient for addressing the complexity of variables that may be considered to determine compatibility between two individuals, and considering superficial variables that do not address complexity and thus may be considered to determine only limited aspects of compatibility between two individuals.

Businesses may utilize older tests, such as the Four Temperaments Test (O4TS), which focus on identifying psychological disorders or temperaments, for addressing or predicting compatibility between individuals in a prospective work relationship in a business or other organization.

Other tests may be personalized to suit individual needs of a user. Such tests may focus on productivity. According to disclosed subject matter, a system may include disproportionate consideration or emphasis on variables or elements, such as personality, for example, that have disproportionate impact for determining productivity. According to disclosed subject matter, a system for matching individuals for positions to perform work in organizations may include primary variables. Disclosed subject matter recognizes and satisfies need for improved systems that match individuals in a scientifically accurate way. Disclosed subject matter provides a social network having a system for matching individuals in a scientifically accurate way. Embodiments may use a neuro-social network to meet the matching needs of both individuals and businesses. The present disclosed subject matter theorizes that relationships are at the center of a compatible fit whether in a business, family or marriage. These relationships are based on the effect of an individual's neural network and neurohormones, which regulate how individuals interact with and relate to each other, primarily what we refer to as “relationship personality”. Disclosed subject matter provides a system for predicting compatibility between individuals considering prospective personal relationships, wherein the system considers relationship personality variables for each individual. Disclosed subject matter also provides a system for predicting compatibility between individuals considering a prospective business or employment relationship, wherein the system considers relationship personality variables for individuals in the prospective business or employment relationships.

In embodiments, a series of tests may measure relationship personality variables of an individual, and may enable the satisfaction that individuals may experience years into the relationship, to be identified. The present disclosed subject matter may utilize a “needs based” model of high and low needs. The personality tests may identify needs by a user's personality levels for a variety of relational variables that may be important to a relationship, such as communication, intimacy, adaptability, and interactivity. Additionally, methods and personality tests may also utilize social variables to identify compatibility between two individuals that may also help to strengthen the relationship. These two sets of variables complement each other and reinforce the algorithm's results.

The disclosed methods and personality tests may skip over social personality and may provide measurement of relational personality; they may prevent two individuals from starting a relationship if their scores reveal that they're unmatched. For individuals in a relationship, the test may help couples identify “blind spots” in order to improve their relationship and increase bonding. Consequently, the test may help couples and singles identify their personality type, understand their needs and the needs of their partner, and act on them in order to produce the chemical bonding hormone, oxytocin so that they can sustain a long-term healthy relationship.

For singles, the methods and personality tests may reveal whether a first person interested in a second person may be a perfect match based on the first person's personalities alone. A test may provide this before two people go on a first date. A test may further determine how a relationship may unfold years later even before two people become committed. Additionally, a test may also help singles change how they date so they only attract compatible personalities.

For couples, the disclosed methods and tests may identify each partner's personality and needs in the relationship. The tests may reveal problems years before they even occur and guide couples on how to specifically avoid relationship ending conflict. The tests may further predict how one partner will behave in the relationship years from now. Additionally, the tests may also reveal a partner's undisclosed feelings so couples can solve problems at the deepest level.

The disclosed methods and tests, in embodiments, may identify three types of matched couples: extreme couples, mixed couples, and inverted couples. The test may identify an extreme relationship between a classic high and a classic low: one partner is a high/high type and the other a low/low type. This relationship may typically be the rockiest. The high/high type partner has high emotional needs as well as high communication needs. The low/low type partner has low communication and low intimacy needs. This individual may have likely gotten sucked or suckered into the relationship because of the functional faking that his/her partner had to do to convince him/her that they were a match, communicatively and emotionally.

Concerning mixed couples, there exist two types: high/high:high/low and high/low:low/low. In the high/high:high/low mixed relationship, the first partner may come with a high need for communication as well as a high need for emotional support and expression. The other partner may bring a high need for communication but a low need for emotional expression and support. Couples who have no communication problems may complain about some type of emotional imbalance, where one partner wanted to be hugged and pampered, and needed to have the affirmation of just knowing, seeing, or hearing how much her partner loves her and cares about him/her. These partners may be in need of the “oxy-touch,” the touchy-feely-ness that promotes Oxytocin flow. Several of those partners may express how horribly unfulfilling their marriages and relationships may be with all the communication, but without adequate touch.

The high/low:low/low mixed relationship may be similar to the first, except that the commonality lies with the second scale, the emotional scale. Both partners may be quite content to live in a cuddle-free zone, where hugs are reserved for birthdays, and kisses make great chocolate stocking stuffers at Christmas. The complaints from this couple may always be in the area of communication. This may make the areas of conflict with this pair quite predictable. But this high/low discrepancy may also tell us where a couple might run into problems with infidelity. Not getting her communication needs met, a wife may decide—even on an unconscious level—to form bonds at work. And she may form those bonds predictably with personality types who talk with her often, until bonds form that at first go unnoticed. The good intentions and values of the Oxytocin-deprived mate may not be enough to prevent the unconscious forces of communicative bonding.

The high/low:low/high inverted relationship may be the most unique of all the relationships. A wife may have a high communication need and low emotional needs. Her husband may have the opposite. He may have a low need for communication and a high need for emotional expression. He may keep complaining about his unaffectionate wife, just as she may complain about her silent partner. So what we have here is a husband who is giving what his wife doesn't need while desperately needing what his wife can't give. It is important to note that the further apart individuals are on the scale, the more conflict they will have due to needs not being met in the relationship.

A number of personality traits may contribute to variables and/or may be variables associated with a system for matching. These traits may include, but are not limited to communication, intimacy, adaptability, interactivity (conflict resolution), interactivity (personal time), and social.

The amount of communication needed or received may affect satisfaction more than anything else. Couples may be compatible if they receive the optimum amount of communication, not too much and not too little, based on their personality types. Too much may lead to resentment, while too little may cause frustration. The frustration may stem from the fact that Oxytocin, the bonding hormone may be produced in too little quantity to foster feelings of closeness of relationship satisfaction. Though the world appears to have become more social with new social networks and ways to communicate springing up every day, most do not produce Oxytocin at all, giving a semblance of connectedness without the feeling of being truly connected or bonded. For example, though most millennials prefer to send a text rather than make a phone call, texting, produces no Oxytocin at all.

A high communicator may display one or more of the following: use of more words; often nonfunctional, chit-chat; talk in swirls, tangents, bursts, with uninterrupted flow; multi-threaded conversation; much repetition; very disclosing; functional gossiping: 21,000 words spoken per day (including gestures). A low communicator may display one or more of the following: fewer words; functional communication; sound bites; one conversation at a time, no multi-threading; no repetition; nondisclosure; no gossiping or casual chit chat: 7,000 words spoken per day. Less talkative low-types often complain about having difficulty breaking into the conversation of, or keeping up with, a group of high communicating high-types.

The amount of intimacy needed or received may affect satisfaction as well. Couples who received adequate communication may still report lower levels of relationship satisfaction if intimacy levels are low. Proximity may begin the hormonal flow, which may increase gradually with the amount and quality of contact. Research may show that during the highest level of intimate contact—sexual intercourse, the body may produce five times its baseline amount of Oxytocin. Couples may be compatible if they receive the optimum amount of intimacy, not too much and not too little, based on their personality type.

A high intimacy person may display one or more of the following: share nonfunctional conversation; spend time together; emote (express feelings, physical interaction); touch (hugging, hand holding, even spooning during sleep). A low intimacy person may display one or more of the following: prefer engaging in common activities like golfing, cycling, playing pool etc.; share common interests; share functional ideas and similar topics of interest like sports, politics, hunting, etc.

In embodiments, adaptability may refer to the willingness of partners to adapt to meet each other's needs and to deal with differences. It may be a measure of both flexibility with and tolerance of those differences. It is also a measure of an individual's willingness to understand and immerse himself or herself in a partner's world without losing one's sense of self or one's individuality. If this is done wholeheartedly by each, a unique oneness and a special bond may be possible. Tolerance is on the low end of the scale and assimilation is on the high end. Adaptability, as far as it relates to compatibility, may work even when one partner does most of the adapting. That is, as long as they understand it, they expect it, and they're okay with it. Though not the ideal, a relationship only needs one person in the relationship who may be willing to adapt. Certain research may confirm that high communicators are more likely to be adaptable.

Conflict resolution interactivity may require that people use the same style to resolve conflict. The interactivity results may tell whether a couple has what it takes to resolve conflict and settle differences successfully. How soon may each partner want to resolve an issue? Is it immediately or after some time has elapsed? The higher the communication scores are the more likely the individuals are to resolve conflict immediately. Interactivity may work differently. Whereas communication and intimacy facilitate the flow of Oxytocin which promotes bonding, resolving conflict may have the potential to disrupt that flow if partners are not on the same page or utilize different resolution styles.

A high interactivity person, or conflict engager, may display needs to resolve conflict immediately. When the other partner doesn't reciprocate, withdraws, or the conflict continues to go unresolved, it causes stress and anxiety for both the engager as well as the one being pursued. High-types may pour in too much emotion or passion and too much verbosity and verbal communication into the interaction and may push low-types away. Low-types on the other hand may be often too unwilling to work through the initial discomfort to find resolution. The interaction may now feel like a confrontation with no hope for resolution. Some high-types may use interaction (conflict) to meet their communicative need for Oxytocin (the bonding hormone) when the other partner may be low in communication. This should be identified and avoided.

A low interactivity person, or conflict avoider, may display needs to process the conflict before coming to a resolution. This processing may take anywhere from hours to a couple of weeks. This personality type may sometimes prefer to ignore the problem, sweep it under the rug, and allow time to heal all wounds. Needless to say, this may be unacceptable to many high-types who often can't sleep at night if a matter is left unresolved. Stress and anxiety may build the longer the problem goes unresolved for high-types.

When a partner (high-type) confronts and the other (low-type) withdraws, trying desperately to flee or disengage from the conversation because of the anxiety that is felt, the other partner (low-type) may be forced to engage so that the argument escalates, causing this unresolved, back and forth exchange that continues to intensify. Stress and anxiety levels may continue to increase during the conflict that may often spiral out of control, leaving the matter unresolved. Psychologists and therapists may refer to this as the negative feedback loop.

Personal time interactivity may focus on the difference between how much you and your partner use various devices as well as time spent on media. There may be no right or wrong amounts of usage. However, problems may arise in relationships or social settings when time spent on devices severely cuts into time that could be spent interacting with significant others. This may interfere with Oxytocin flow and bonding. This as far as match-making goes, is a new phenomenon. This did not exist in this form twenty-five years ago, nor did the problem of addiction to video games or cyber porn, which are extreme aberrations of problems with interactivity.

Social compatibility is an important component of the neuro-social bond. All personality types may value sharing social activities with their partners to some degree. But for low-types it's an absolute need. Without the option of receiving the Oxytocin need to bond through touch or talk, low-types must resort to another source. Social interactions through sharing activities such as fishing, hunting, racing, etc. or discussing more functional topics of interest may provide for their Oxytocin needs. Spikes of Oxytocin have been measured from basketball players celebrating a winning shot as well as from footballers celebrating a touchdown and also soccer players jumping on each other's backs after a goal is scored. This variable has two main pieces, social interest and social activity. If the social activity a couple engages in is low, even if the other dimensions are high, it may lower relationship satisfaction.

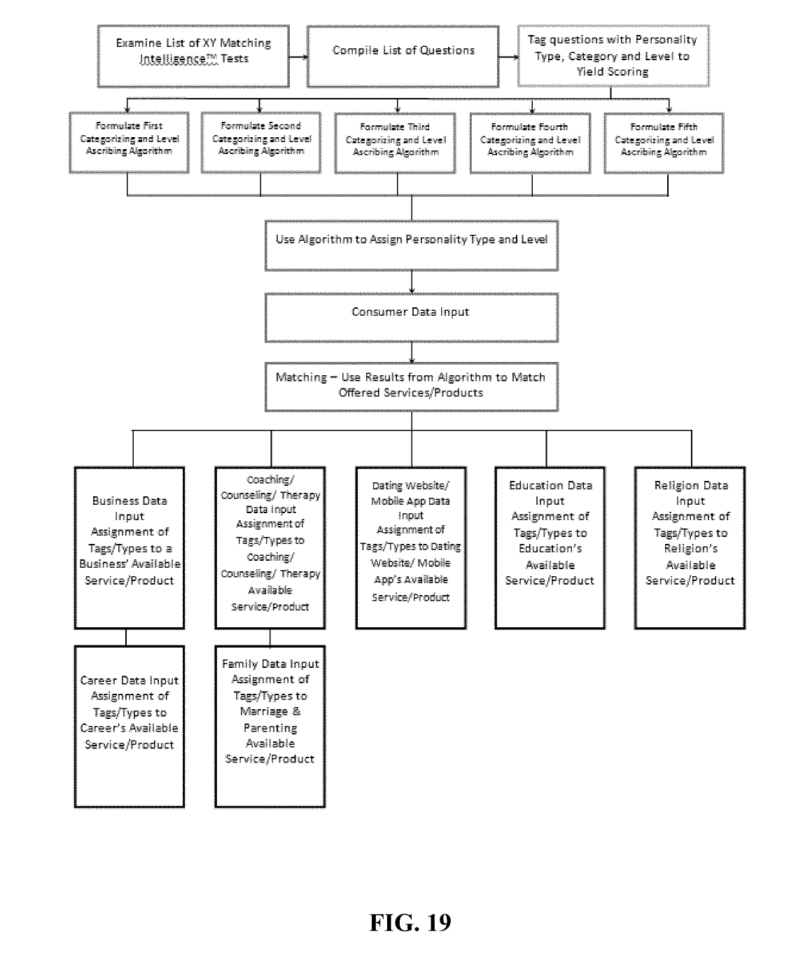

FIG. 19 is a flow diagram illustrating an exemplary method for optimal matching of individuals seeking to establish relationships in accordance with embodiments. System 200 and method 400 may disclose aspects of those found in FIG. 19. A user utilizing a system in embodiments of the disclosure may execute steps found in the method. The user may examine a list of matching intelligence tests, examples of which may be found in FIG. 12. These tests may comprise questions relating to potential relationships of an individual. The system may then compile a list of questions related to an intelligence test chosen by an individual. The questions may be tagged with information such as, but not limited to personality type, category, and level to yield scoring. Based on the tagging of questions, at least one of a first, second, third, fourth, and fifth ascribing algorithm may be assigned to the questions to assign a personality type and level to the individual once data is input by the individual (in this example, answers to the questions provided to the individual).

Once the personality type and level have been assigned to the individual, the individual may be matched with potential relationships concerning services and/or products. These may include, but are not limited to business data input/assignment of tags/types to a business' available service/product; coaching/counseling/therapy data input/assignment of tags/types to coaching/counseling/therapy available service/product; dating website/mobile app data input/assignment of tags/types to dating website/mobile app's available service/product; education data input assignment of tags/types to education's available service/product; religion data input/assignment of tags/types to religion's available service/product; career data input/assignment of tags/types to career's available service/product; and family data/Match Mating Portal/Chat Room, Mobile App input/assignment of tags/types to marriage & parenting available service/product. In summary, an individual, based on their personality type and level, may be matched with potential relationships relating to business, coaching or counseling, dating, education, religion, careers, and family.

In embodiments, it is noted that the disclosed methods and personality tests may embody a needs-based model.

For the purposes of this disclosure, the terms “individual” and “user” may be synonymous.

The presently disclosed subject matter incorporates an Oxytocin Algorithm for using the psychological effects of Oxytocin and its moderating effects on the development of romantic bonds as the basis of the claims made in this patent application.

Oxytocin is a hormone, a neuropeptide naturally produced in the hypothalamus region of the brain before its release into the bloodstream. It plays a role in social bonding and is the primary agent responsible for monogamous behavior in animals, including human beings (Nardi, 2003). Three percent of mammals are monogamous leaving 97% that are not. But relationship formation is governed not only by the amount of oxytocin naturally produced in each individual but by the number of oxytocin receptors available to absorb the oxytocin present in blood plasma. In males, the counterpart to Oxytocin is Vasopressin and provides the same behavioral response as Oxytocin does in females. (Nardi, 2003)

Oxytocin facilitates bonding by reducing stress (by inhibiting the release of cortisone and adrenocorticotropic hormone), and increasing trust, romantic attraction and subsequently monogamous pair bonding. The hormone also affects the social distance between adult males and females. (Zak, 2012)

The rate of Oxytocin production can be measured in the blood plasma of human beings and can be used to predict the likelihood of bonding between two individuals. It can therefore be used to predict the likelihood that two individuals would find their relationship (or bond), mutually satisfying. Measuring oxytocin levels in individuals for the purpose of match making, by taking blood samples is inconvenient, impractical and intrusive. Therefore, the method we use examines the behavior of individuals to extrapolate levels of oxytocin that would correspond to the romantic behavior they report as typical. Since bonding involves getting one's needs met and in turn being able to meet a prospective partner's needs, the model used in the creation of this algorithm is essentially a needs-based model.

Since research shows that we experience a spike in Oxytocin production just prior to making a bid from our partners for more communication, intimacy, connectedness (or time together), a successful algorithm must address differences in the level of our individual needs.

This model looks at four aspects of need, each of which produces the oxytocin needed to bond with significant others, according to their high and low needs as well as a whole range of needs in-between. These four dimensions or lead variables are Adaptability (the need to connect), Communication (Need), Intimacy (Need), and Interactivity (or the need to resolve conflict in a timely manner).

Personality and Oxytocin: The realization that personality can be expressed on a continuum rather than as a binary (2) type or categorical (4) type model, is slowly taking shape in studies on personality. One scientist compares the brains of extroverts with that of introverts and concludes that this facet of one's social personality is not simply a binary choice. We may not be either extrovert or exclusively introverted. And though our brains are not wired differently, they may be activated differently. The neurotransmitter dopamine, is implicated, and has quite a lot to do with whether we are energized by spending time alone or whether our energy comes from being with friends. Research is showing that we exist on a spectrum somewhere between total introvert and extreme extrovert (Bushack, 2014).

In the same way, we have identified behaviors associated with forming strong relationship bonds or being somewhat detached even in a relationship. This gives rise to an individual's “relationship personality.” When carefully paired and matched with someone else of like personality, it creates a bond that is more long lasting and satisfactory. The theory is referred to as XY Theory (Jacob, 2012) and hypothesizes that unlike the social personality variables: extroversion/introversion, the relationship personality relies on another neurotransmitter, oxytocin (in women) to facilitate bonding. A variant of the molecule, vasopressin, with two amino acids less is the neuropeptide, affects how males bond (Phelps & Young, 2003). We've categorized the relationship personality into 4 behavioral dimensions with related traits, and 8 levels of need from Extremely Low to Extremely High need, which research suggests would correspond to the level of measurable oxytocin a man or woman possesses.

Numerous studies show that hormones like Oxytocin cause neurological and chemical changes that shape and drive personality but here we focus only on the impact those personality differences have on bonding and relationship formation.

Personality analysis is used in this algorithm as we attempt to match individuals according to compatible personalities. This requires personality analysis. A personality is typically defined as the attributes and behavioral traits that may be categorized and analyzed to predict how an individual might feel or act in specific circumstances. Carl Jung (1875-1961), a contemporary of Freud, was the best known if not the first psychiatrist to postulate that personalities tended to exhibit themselves in distinct and categorical ways. He felt, as we do, that people differ from each other in ways that depended on the degree to which they possessed certain traits that he thought could be categorized into four types. His types were thinking, feeling, sensation, and intuition: A categorization that is still used by millions today, who have interest in temperaments.

Social vs. Relational Personality: The majority of research studies focus on the social personality with social variables such as introversion/extroversion, agreeableness etc. and social personalities affecting our social relationship such as at work, in sports or church (Maiden, Peterson, Caya, Hayslip, 2003). Slowly but surely we've begun to realize a phenomenon some researchers refer to as the “Newness Principle” (Niven and David, 2006). The observation requiring some hypothesizing is simply this: We tend to be a lot nicer to strangers than the people we love the most. Any inclination of mine to quickly shoot this down is removed by the fact that I have clear and distinct memories of this very fact as my parents' relationship got bogged down by this very thing argument. That is of my mother accusing my father of being kinder, gentler and more loving to everyone else than he was to her and to us, his own children. Some researchers are convinced this is a case of “familiarity breeding contempt”. (Stanton)

Other scientists believe that it is “our tolerance for all things we've always disliked (in loved ones), diminishing over time. (Likerman, A. 2014). Whereas both of these postulates have merit, neither can completely explain why this phenomenon occurs only in the romantic or family settings reserved for our most loved ones. Or why this deterioration of tolerance seldom occurs in a work setting among colleagues or in any other setting where those around us are mere acquaintances we care less about.

It is interesting to note that when psychologists and researchers touch on the topic of personality they are almost always referring to the social personality with its five-factor theory of personality (also known as the Big Five) (McCrae and Costa, 2008). But what of more intimate and romantic relationships and the millions of significant others still mistreated at the hands of those who purport to love them the most?

To date, there are only two authors who have made the obvious leap to explain this discrepancy by hypothesizing that perhaps we each have two distinct personalities: Dr. Baumeister, the sociologist who wrote the book Love, Is There Anything Good About Men and Dr. John Jacob, author of XY Theory, How Personality Can Sabotage Dating and Jeopardize Your Marriage. Both authors contend that the real difficulty in matching individuals romantically lies in the very fact that we tend to date socially, displaying our social characteristics and traits (such as extroversion or agreeableness, only to get deep into a relationship and realize that relationship personality is often nothing like the social personality that will require an adjustment for the rest of our lives. Knowing this, our immediate goal was to create an algorithm that would measure the relationship personality only as a means of finding partners who can bond for life. Since research showed that oxytocin is the neuropeptide primarily implicated in bonding, we made the decision to measure and match couples based on their natural levels of oxytocin extrapolated from their bonding behavior and needs.

The relationship between oxytocin and intimacy is well documented. Men and women who have higher needs for intimacy and by extension the oxytocin that produces it, tend to be more critical of partners who are less affectionate. But this correlation is far from simplistic. One Stanford study suggests that release of oxytocin that is generated from touch for instance triggers the release of serotonin in the brain. In a chain reaction the serotonin activates the reward circuitry by releasing dopamine which floods the nucleus acumbens in the brain leaving its owner with a happy satisfied feeling. Malenka and Dolen, university professors at Stanford University School of Medicine, state that oxytocin is secreted directly to a spot on the nucleus acumbens of the brain (Molenka & Dolen, 2013) and is the only hormone to deliver this directly. Let's talk about oxytocin and intimacy.

Intimacy Need: One study was conducted using massage therapy on 24 participants who received light massage, a well-known means of increasing oxytocin flow. Participants were massaged for 15 minutes. Blood plasma was extracted from antecubital veins before the massage and another 20 ml were drawn after. The blood was chilled on ice to 4 degrees Celsius and spun at 1500 rpm for 12 minutes. Each vial contained 494.63 pg/ml. It was found that the light touch massage increased oxytocin volume in blood plasma by 27% in the 24 participants, thereby increasing bonding and decreasing cortisol levels, the stress hormone that pushes couples apart, by 24%. This study conclusively indicates that getting what you need by way of intimacy increases bonding and feelings of closeness and not getting what is optimal decreases this feeling (Morhenn, Beavin, Zak, 2012). In our research, we placed our participants into 8 groups that reflected their varying levels of need. Partners tended to show maximum satisfaction if their needs fell on the same level. Participants displayed affectionate behaviors that in turn caused them to secrete similar quantities of blood plasma oxytocin. Those in groups where levels were the furthest apart (at a minimum of 2 levels), reported the least amount of relationship satisfaction.

The need for intimacy in adequate quantities is clearly a reflection of how much oxytocin is naturally produced in the body. Physical Intimacy and emotional intimacy, verbally and non-verbally expressed are all reflections of the need for Oxytocin. This dimension seeks to match individuals with a high need for intimacy with similarly high need individuals. Because no other dimension or matching variable produces more oxytocin than intimacy, the algorithm contains questions that measure this dimension carefully.

Adaptability: Adaptability is also related to the ability to change as needed in a relationship or to adapt to a partner's inability to do so. As such, tolerance for differences in each other or in our environment is an excellent way to measure a partner's adaptability. Adaptability predicts a couple's relationship satisfaction which is also tied to individualized oxytocin levels.

Research was done on mammals which sought to investigate the link between oxytocin and tolerance. Marmosets were injected with oxytocin to determine if their tolerance for changes in their family unit would increase. Results showed that refusals by males decreased while willingness to help increased considerably, showing there is an increase in tolerance as oxytocin levels increased. Since all mammals possess the oxytocin receptors, it is hypothesized that as humans, we too would see an increase in cooperation and tolerance. In a study we conducted, oxytocin was administered to 10 participants intranasally by way of a spray. Using synthetic oxytocin produced the same effect as the marmoset study, and the spouses of each participant witnessed drastic increases in cooperation from their partner as measured on the “Cooperativeness Scale” (Saito and Makamura, 2011). Greater relationship satisfaction is achieved when adaptable individuals are matched with like partners. Our adaptability scale comprises of 8 levels of tolerance or cooperativeness which corresponds to the level of oxytocin naturally occurring in the blood plasma of individual partners.

Adaptability is a measure of an individual's need to connect and to feel connected to their partner. High-adaptability individuals are able to connect to a partner by adapting to the partner's differences or adopting those personality differences and personal preferences. Either way, change is required to bring two individuals in sync with each other and exercising the flexibility required to make the necessary changes produces the oxytocin necessary to strengthen the bond! Test questions comprise about 25% of the algorithm used to measure this dimension.

Communication Need: The next two sections: communication and conflict resolution are both directly affected by the quantity of oxytocin naturally produced by the body or that can be accessed intranasally. The natural production of the hormone is controlled by a positive feedback mechanism. The mechanism involves a trigger such as chit chat or emoting: like using words of affirmation. Once triggered, the oxytocin that is produced causes an action in the body such as more communication or self-disclosure. It is this same effect that causes couples, after sexual intercourse, to engage in “pillow talk”. Studies indicate that the pillow talk couples engage in is sometimes more bonding than the sexual act itself (Borreli, 2013).

More importantly, the feedback loop that occurs, where conversation follows spikes of oxytocin (sexual intercourse produces 5 times the basal rate) results in behavior that produces more oxytocin that gives rise to a continuous (virtuous) cycle. Several studies have indicated that high oxytocin partners require three times as many words per day (20,000) as do low oxytocin individuals (7,000 words). Even when competing studies suggest a lower word count, the ratio is still 1:3 (Pease, B., & Pease, A., 1998). In other research, scientists are finding that women with high levels of oxytocin complained about insufficient contact from partners, or that they weren't understood. Hence the reason why communication is pivotal to any algorithm designed to bring “soulmates” together.

This is the only algorithm to date that has been created to measure communication need instead of communication style. All other theoretical frameworks are designed to measure how individuals communicate in order to match them up with someone with similar styles. This theory purports that how much communication an individual needs is exponentially more significant as it relates to compatibility. Simply put, the more an individual communicates, the more oxytocin is produced. By asking questions designed to unearth how much communication is desired or preferred, the algorithm is in effect measuring how much oxytocin flows and hence the strength of the bond needed for relationship satisfaction. The communication scale has 8 levels of need.

Interactivity: Conflict Resolution—Research showing that the neurohormone oxytocin increases positive communication during times of conflict and stress, are numerous. In 2009, one study (double-blinded, placebo controlled) was conducted on 47 heterosexual couples (94 subjects in total). They were given either oxytocin or a placebo intranasally before engaging in a couple conflict discussion in a laboratory. The session was videotaped and coded for verbal and nonverbal interaction such as eye contact and self-disclosure. The participants were 20-50 years old and were either married or cohabitating for at least a year. They were administered either 40IUs (5 puffs in each nostril) of Oxytocin and allowed 45 minutes for the drug to take effect before discussing. At the end of this time they were administered a relationship questionnaire and a stress questionnaire.

The results indicated that Oxytocin significantly increased positive communication behavior when compared to negative behavior exhibited during the couple conflict discussion. The hormone was shown to attenuate analyzed responses in the brain while cortisol levels dropped considerably as Oxytocin reduced the stress associated with the exchange.

Given these results, and the fact that there is no relationship that escapes conflict, it became necessary to include this in any algorithm that takes the inevitable, under consideration or seeks to match individuals whose natural Oxytocin levels can make it possible to manage conflict successfully. (Ditzen, Schaer, Gabriel, Bodenmann, Ehlent & Heinrichs, 2009).

This dimension is a measure with numerous facets, the chief of which is an Individual's need to resolve conflict within a specific predictable timeframe, or not at all. For high resolution individuals there is a need to resolve conflict and differences as quickly as possible, right away or at least that same day. Low resolution individuals need time to process and can put off resolving till the next day if not several days later. The Oxytocin required for bonding is produced with maximum effect if conflict is resolved within an individual's preferred timeframe but has the opposite effect, if one is forced to resolve issues too quickly or slower than is preferred. Some high resolution individuals have been known to be besieged with insomnia and anxiety if a matter is not resolved before going to sleep at night. Since forging new relationships requires settling differences as quickly and as painlessly as possible so that a new couple can bond more and more, Interactivity plays a key role in matching any two individuals successfully.

These, are the four pillars of our algorithm, designed primarily to match individuals according to their Oxytocin driven needs.

The embodiments described above are exemplary and are not to be taken as limiting in any way. They are merely illustrative of the principles of the disclosure. Various changes, modifications and alternatives will be apparent to one skilled in the art. Accordingly, it is intended that the art disclosed shall be limited only to the extent required by the appended claims and the rules and principles of applicable law.

What is claimed is:

1. A system for optimally matching individuals seeking to establish long-term mutually satisfying personal relationships according to a user's relational and neuro-social personality, the system comprising:
a display;
a processor;
a user interface providing a series of queries, the user interface providing sets of answer alternatives corresponding to each one of the series of queries, the user interface requiring selection of a selected answer from each of the sets of answer alternatives, the user interface receiving a series of selected answers corresponding to the series of queries, each one of the series of queries correlating with a discipline relating to a need of an individual;
a relational personality scale, the scale comprising a set of four identified personality classifications into which the individual is categorized based upon a range or continuum of personality traits assigned based on the selection of a selected answer from each of the sets of answer alternatives, wherein said personality categories comprise at least one of a communication dimension, an intimacy dimension, an interactive dimension, and an adaptability dimension, all of which dimensions relating to an ability for generating oxytocin within a user, said generating oxytocin correlating to an ability of the user to enter into and maintain long-term mutually satisfying personal relationships; and
an identified first algorithm having a configuration adapted to utilize a multiple choice the selection of one of four answers from each of the four sets of multiple choice responses and to identify one of the set of four identified personality classifications;
wherein the processor having a configuration adapted to apply the first algorithm to selection of a selected answer from of the sets of multiple choice responses to identify one of the set of four identified personality classifications the individual is categorized for the purpose of matching the individual to another individual or opportunity.

2. The system of claim 1, the set of four identified personality categories comprising a communication dimension, an intimacy dimension, an interactive dimension, and an adaptability dimension.

3. A system for matching individuals seeking to establish personal relationships according to claim 1 and further comprising:
an automated test administration module operable to receive a set of input data, the set of input data corresponding to a set of selected responses each comprising a single answer selected by the individual from a closed, predetermined set of available answer alternatives presented to the individual with a corresponding predetermined query.

4. A computer-implemented method of optimally matching individuals seeking to establish at least one personal relationship, the method comprising:
providing at least one service preference from the user interface;
receiving at least one service preference from the user interface in the form of user input;
providing a series of queries to an individual via a user interface;
providing, via the user interface, sets of answer alternatives corresponding to each one of the series of queries, the user interface requiring selection of a selected answer from each of the sets of answer alternatives, each answer alternative in the sets of answer alternatives comprising a value interpretable by a processor;
receiving a set of inputs from a user interface, the set of inputs being single answer selections from a closed, predetermined set of answer alternatives obtained by presenting a series of mandatory queries to an individual;
categorizing the individual, via a first algorithm housed within a processor, into one of a set of four identified personality categories based upon behaviors that the individual is predicted to exhibit in relation to a relational interaction with another individual and based on the set of inputs, the four identified personality categories representing a level of at least one of communication and intimacy correlating with the set of inputs, the set of four identified personality categories aspects of a relational personality index;
and applying, via the processor, the first algorithm to the selection of a selected answer from each of the sets of answer alternatives to identify one of the set of four identified personality categories the individual is categorized for the purpose of matching the individual to an opportune individual or opportunity.

5. The method of claim 4, the set of four identified personality categories comprising a communication dimension, an intimacy dimension, an interactive dimension, and an adaptability dimension.
